(19) United States
(12) Patent Application Publication
(10) Pub. No.: US 2024/0305997 A1
(43) Pub. Date: Sep. 12, 2024

(54) METHOD AND DEVICE FOR TRANSMISSION AND RECEPTION OF NETWORK CONTROLLED REPEATER IN UNLICENSED BAND IN WIRELESS COMMUNICATION SYSTEM

(71) Applicant: Samsung Electronics Co., Ltd., Gyeonggi-do (KR)

(72) Inventors: Kyunggyu LEE, Gyeonggi-do (KR); Taehan BAE, Gyeonggi-do (KR); Yeongeun LIM, Gyeonggi-do (KR); Hyoungju JI, Gyeonggi-do (KR); Kyungjun CHOI, Gyeonggi-do (KR)

(21) Appl. No.: 18/443,595

(22) Filed: Feb. 16, 2024

(30) Foreign Application Priority Data
Feb. 27, 2023 (KR) 10-2023-0025575

(51) Int. Cl. H04W 16/14; H04W 72/0446; H04W 74/0808

(52) U.S. Cl. CPC H04W 16/14; H04W 72/0446; H04W 74/0808

(57) ABSTRACT

The disclosure relates to a 5G or 6G communication system for supporting a higher data transmission rate. A method and a device are provided for transmitting and receiving an NCR in an unlicensed band. A method performed by an NCR in the unlicensed band includes receiving, from a BS, control information indicating a forwarding window for transmitting data to a UE; performing a CAP for a channel between the NCR and the UE to identify whether the channel is idle; and in case that the channel is idle, receiving, from the BS, the data in the forwarding window, and transmitting, to the UE, the data in the forwarding window.

### CROSS-REFERENCE TO RELATED APPLICATION(S)

This application is based on and claims priority under 35 U.S.C. § 119 to Korean Patent Application No. 10-2023-0025575, which was filed in the Korean Intellectual Property Office on Feb. 27, 2023, the entire disclosure of which is incorporated herein by reference.

### BACKGROUND

### 1. Field

The disclosure relates generally to a wireless communication system (or mobile communication system), and more particularly, to a method and device for a network-controlled repeater (NCR) in an unlicensed band of a wireless communication system.

### 2. Description of Related Art

5^{th} generation (5G) mobile communication technologies define broad frequency bands such that higher transmission rates and new services are possible, and can be implemented in “sub 6 GHz” bands such as 3.5 GHz, and in “above 6 GHz” bands, which may be referred to as mm Wave, including 28 GHz and 39 GHz. In addition, it has been considered to implement 6^{th} generation (6G) mobile communication technologies (or beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

Since the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input, multiple output (MIMO) for mitigating radio-wave path loss and increasing radio-wave transmission distances in mm Wave, supporting numerologies (e.g., operating multiple subcarrier spacings (SCSs)) for efficiently utilizing mm Wave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, a non-terrestrial network (NTN), which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

An aspect of the disclosure is to, when an NCR operates in an unlicensed band of a wireless communication system, and a channel access procedure (CAP) is performed independently on a backhaul link and an access link, address performance and reliability reduction due to a different channel access times for each link.

Another aspect of the disclosure is to provide a method for a base station (BS) to perform a CAP control operation on an access link of an NCR in an unlicensed band via control signaling in a wireless communication system.

In accordance with an aspect of the disclosure, a method is provided for an NCR in an unlicensed band in a wireless communication system. The method includes receiving, from a BS, control information indicating a forwarding window for transmitting data to a UE; performing a CAP for a channel between the NCR and the UE to identify whether the channel is idle; and in case that the channel is idle, receiving, from the BS, the data in the forwarding window, and transmitting, to the UE, the data in the forwarding window.

In accordance with an aspect of the disclosure, a method is provided for a BS in an unlicensed band in a wireless communication system. The method includes performing a first CAP for a first channel between the BS and an NCR to identify whether the first channel is idle; and in case that the first channel is idle, transmitting, to the NCR, control information indicating a forwarding window for transmitting data to a UE, and transmitting, to the NCR, the data in the forwarding window.

In accordance with another aspect of the disclosure, an NCR is provided or use in an unlicensed band in a wireless communication system, The NCR includes a transceiver; and a processor coupled with the transceiver and configured to receive, from a BS, control information indicating a forwarding window for transmitting data to a UE, perform a CAP for a channel between the NCR and the UE to identify whether the channel is idle, and in case that the channel is idle, receive, from the BS, the data in the forwarding window, and transmit, to the UE, the data in the forwarding window.

In accordance with another aspect of the disclosure, a BS is provided or use in an unlicensed band in a wireless communication system, The BS includes a transceiver; and a processor coupled with the transceiver and configured to perform a first CAP for a first channel between the BS and an NCR to identify whether the first channel is idle, and in case that the first link is idle, transmit, to the NCR, control information indicating a forwarding window for transmitting data to a UE, and transmit, to the NCR, the data in the forwarding window.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a time-frequency domain transmission structure of long-term evolution (LTE), evolved universal terrestrial radio access (E-UTRA)), LTE-Advanced (LTE-A), NR, or a wireless communication system similar thereto according to an embodiment;

FIG. 2 illustrates structures of a frame, subframe, and a slot in a 5G system according to an embodiment;

FIG. 3 illustrates an example of a BWP configuration in a wireless communication system according to an embodiment;

FIG. 4 illustrates a downlink (DL) control channel in a wireless communication system according to an embodiment;

FIG. 5 illustrates a DL control channel in a wireless communication system according to an embodiment;

FIG. 6 illustrates allocation of time domain resources of a physical DL shared channel (PDSCH) in a wireless communication system according to an embodiment;

FIG. 7 illustrates allocation of time domain resources of a PDSCH in a wireless communication system according to an embodiment;

FIG. 8 illustrates a method of configuring a semi-static hybrid automatic repeat request-acknowledgement (HARQ-ACK) codebook in an NR system according to an embodiment;

FIG. 9 illustrates a method for configuring a dynamic HARQ-ACK codebook in an NR system according to an embodiment;

FIG. 10 illustrates a CAP for semi-static channel occupancy in a wireless communication system according to an embodiment;

FIG. 11 illustrates a CAP for dynamic channel occupancy in a wireless communication system according to an embodiment;

FIG. 12 illustrates transmission and reception related to an NCR when the NCR relays between a BS and a terminal according to an embodiment;

FIG. 13 illustrates an access link beam indication by an NCR under control of a BS according to an embodiment;

FIG. 14 illustrates an NCR operating in an unlicensed band according to an embodiment;

FIG. 15A illustrates a BS performing transmission to a terminal by relaying an NCR in a DL of an unlicensed band according to an embodiment;

FIG. 15B illustrates a BS performing transmission to a terminal by relaying an NCR in a DL of an unlicensed band according to an embodiment;

FIG. 16 illustrates access method 1 in a DL of an unlicensed band according to an embodiment;

FIG. 17 illustrates access method 2 in a DL of an unlicensed band according to an embodiment;

FIG. 18 illustrates an NCR access-link channel access failure report in a DL of an unlicensed band according to an embodiment;

FIG. 19 illustrates an uplink (UL) and a DL in an unlicensed band according to an embodiment;

FIG. 20 illustrates a terminal in a wireless communication system according to an embodiment; and

FIG. 21 illustrates a BS in a wireless communication system according to an embodiment.

### DETAILED DESCRIPTION

Hereinafter, embodiments of the disclosure will be described in detail with reference to the accompanying drawings.

In describing the embodiments, descriptions related to technical contents well-known in the art to which the disclosure pertains and not associated directly with the disclosure will be omitted. Such an omission of unnecessary descriptions is intended to prevent obscuring of the main idea of the disclosure and more clearly transfer the main idea.

Similarly, in the accompanying drawings, some elements may be exaggerated, omitted, or schematically illustrated. Further, the size of each element does not completely reflect the actual size. In the drawings, identical or corresponding elements may be provided with identical or corresponding reference numerals.

Various advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Throughout the specification, the same or like reference numerals designate the same or like elements.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

Herein, a “unit” refers to a software element or a hardware element, such as a field programmable gate array (FPGA) or an application specific integrated circuit (ASIC), which performs a predetermined function. However, a “unit” does not always have a meaning limited to software or hardware. A “unit” may be constructed either to be stored in an addressable storage medium or to execute one or more processors. Therefore, a “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by a “unit” may be either combined into a smaller number of elements, or a “unit”, or divided into a larger number of elements, or a “unit”. Moreover, the elements and “units” or may be implemented to reproduce one or more CPUs within a device or a security multimedia card. Further, according to some embodiments, a “unit” may include one or more processors.

The terms that will be described below are terms defined in consideration of the functions in the disclosure, and may be different according to users, intentions of the users, or customs. Therefore, the definitions of the terms should be made based on the contents throughout the specification.

Herein, a BS is an entity that allocates resources to terminals, and may include at least one of a gNode B, an eNode B, a Node B, a wireless access unit, a BS controller, and a node on a network. A terminal may include a UE, a mobile station (MS), a cellular phone, a smartphone, a computer, or a multimedia system capable of performing communication functions. Of course, examples of the BS and the terminal are not limited thereto. In the following description of the disclosure, technology for receiving broadcast information from a BS by a terminal in a wireless communication system will be described.

The disclosure relates generally to a communication technique for converging Internet of things (IoT) technology with 5G communication systems designed to support a higher data transfer rate beyond 4th generation (4G) systems, and a system therefor. The disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology.

Herein, terms referring to broadcast information, terms referring to control information, terms related to communication coverage, terms referring to state changes (e.g., an event), terms referring to network entities, terms referring to messages, terms referring to device elements, etc., are illustratively used for the sake of convenience. However, the disclosure is not limited by the terms as used below, and other terms referring to subjects having equivalent technical meanings may be used.

In the following description, some of terms and names defined in the 3rd generation partnership project (3GPP) LTE standards may be used for the convenience of description. However, the disclosure is not limited by these terms and names, and may be applied in the same way to systems that conform other standards.

A wireless communication system is advancing to a broadband wireless communication system for providing high-speed and high-quality packet data services using communication standards, such as high-speed packet access (HSPA) of 3GPP, LTE (or E-UTRA), LTE-A, LTE-Pro, high-rate packet data (HRPD) of 3GPP2, ultra-mobile broadband (UMB), IEEE 802.16e, etc., as well as typical voice-based services.

As an example of a broadband wireless communication system, an LTE system employs an orthogonal frequency division multiplexing (OFDM) scheme in a DL and employs a single carrier frequency division multiple access (SC-FDMA) scheme in a UL. The UL indicates a radio link through which a UE (or an MS) transmits data or control signals to a BS (or eNode B), and the DL indicates a radio link through which the BS transmits data or control signals to the UE. The above multiple access scheme separates data or control information of respective users by allocating and operating time-frequency resources for transmitting the data or control information for each user so as to avoid overlapping each other, i.e., so as to establish orthogonality.

Since a 5G communication system, which is a post-LTE communication system, should freely reflect various requirements of users, service providers, etc., services satisfying various requirements should be supported. The services considered in the 5G communication system include eMBB communication, mMTC, URLLC, etc.

Generally, eMBB aims at providing a data rate higher than that supported by existing LTE, LTE-A, or LTE-Pro. For example, in a 5G communication system, eMBB should provide a peak data rate of 20 Gbps in the DL and a peak data rate of 10 Gbps in the UL for a single BS. Furthermore, the 5G communication system should provide an increased user-perceived data rate to the UE, as well as the maximum data rate. In order to satisfy such requirements, transmission/reception technologies including a further enhanced MIMO transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the IoT in the 5G communication system. mMTC has requirements, such as support of connection of a large number of UEs in a cell, enhancement coverage of UEs, improved battery time, a reduction in the cost of a UE, etc., in order to effectively provide the IoT. Since the IoT provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC should be configured to be inexpensive, and may require a very long battery life-time because it is difficult to frequently replace the battery of the UE.

URLLC, which is a cellular-based mission-critical wireless communication service, may be used for remote control for robots or machines, industrial automation, unmanned aerial vehicles, remote health care, emergency alert, etc. Thus, URLLC should provide communication with ultra-low latency and ultra-high reliability. For example, a service supporting URLLC should satisfy an air interface latency of less than 0.5 ms, and also requires a packet error rate of 10-5 or less. Therefore, for the services supporting URLLC, a 5G system should provide a transmit time interval (TTI) shorter than those of other services, and also requires a design for assigning a large number of resources in a frequency band in order to secure reliability of a communication link. However, the above-described mMTC, URLLC, and eMBB are only examples of different types of services, and service types to which the disclosure is applicable are not limited to the above-described examples.

The above-described services considered in the 5G communication system should be converged with each other so as to be provided based on one framework. That is, the respective services are preferably integrated into a single system and controlled and transmitted in the integrated single system, instead of being operated independently, for efficient resource management and control.

Furthermore, in the following description, an LTE, LTE-A, LTE Pro, or NR system will be described by way of example, but the embodiments of the disclosure may also be applied to other communication systems having similar technical backgrounds or channel types. In addition, based on determinations by those skilled in the art, the embodiments of the disclosure may also be applied to other communication systems through some modifications without significantly departing from the scope of the disclosure.

### <5G System Frame Structure>

Hereinafter, a frame structure of a 5G system will be described in detail with reference to the drawings.

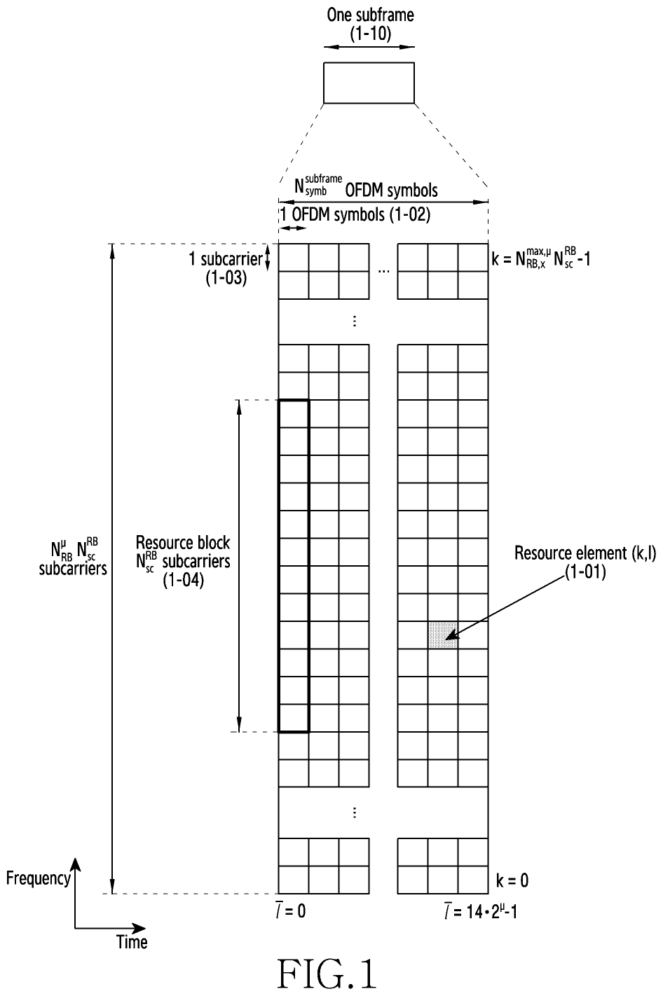

FIG. 1 illustrates a basic structure of time-frequency resources in a wireless communication system according to an embodiment.

Referring to FIG. 1, the horizontal axis represents a time domain, and the vertical axis represents a frequency domain. The basic unit of resources in the time-frequency domain is a resource element (RE) 1-01, which may be defined as one OFDM symbol 1-02 on the time axis and one subcarrier 1-03 on the frequency axis. In the frequency domain, N_{sc}^{RB} (e.g., 12) consecutive REs may constitute one resource block (RB) 1-04. A plurality of OFDM symbols may constitute one subframe 1-10.

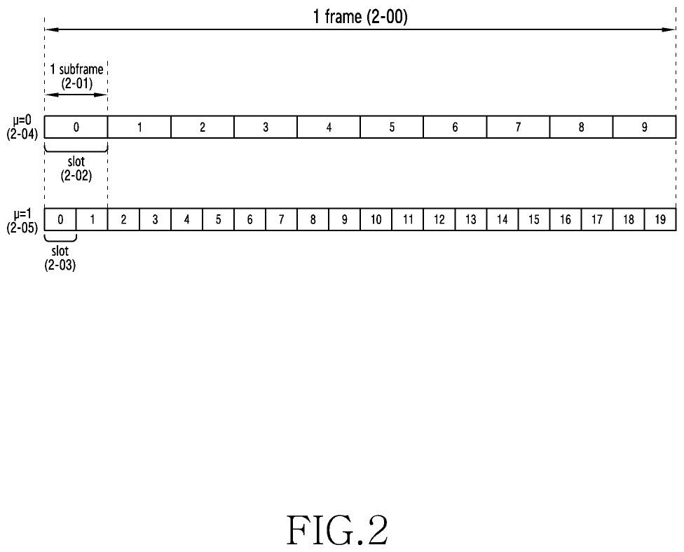

FIG. 2 illustrates a frame, a subframe, and a slot structure in a wireless communication system according to an embodiment.

Referring to FIG. 2, one frame 2-00 may include one or more subframes 2-01, and one subframe may include one or more slots 2-02. For example, one frame 2-00 may be defined as 10 ms. One subframe 2-01 may be defined as 1 ms, and in this case, one frame 2-00 may include a total of 10 subframes 2-01. One slot 2-02 or 2-03 may be defined as 14 OFDM symbols (i.e., the number of symbols per slot (N_{symb}^{slot})=14}. One subframe 2-01 may include one or multiple slots 2-02 and 2-03, and the number of slots 2-02 and 2-03 for one subframe 2-01 may vary depending on a configuration value μ for an SCS 2-04 or 2-05. FIG. 2 illustrates an example in which μ=0 (2-04) and μ=1 (2-05) as a configuration value for an SCS. In the case of μ=0 (2-04), one subframe 2-01 may include one slot 2-02, and in the case of μ=1 (2-05), one subframe 2-01 may include two slots 2-03. That is, the number of slots for one subframe (Nₛₗₒₜ^{subframe,μ}) may vary depending on the configuration value μ for an SCS, and the number of slots for each frame (Nₛₗₒₜ^{frame,μ}) may vary according thereto. Nₛₗₒₜ^{subframe,μ} and Nₛₗₒₜ^{frame,μ} depending on each configuration value μ for a SCS may be defined as shown in Table 1 below.

TABLE 1

| μ | N_{symb}^{slot} | Nₛₗₒₜ^{frane, μ} | Nₛₗₒₜ^{subfrane, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In NR, one component carrier (CC) or serving cell may include up to 250 RBs. Therefore, in a case that a UE always receives the overall serving cell bandwidth, such as LTE, power consumption by the UE may be severe. To adders this type of problem, a BS may configure one or more BWPs for the UE such that the UE is able to change a reception area in the cell.

In NR, a BS may configure an initial BWP, which is the bandwidth of control resource set (CORESET) #0 (or a common search space (CSS)), for the UE through a master information block (MIB). Thereafter, the BS may configure an initial BWP (i.e., a first BWP) of the UE through radio resource control (RRC) signaling, and may transmit a notification of one or more pieces of BWP configuration information that may be indicated through DL control information (DCI) later. Thereafter, the BS may transmit a notification of a BWP identifier (ID) through DCI, thereby indicating a band to be used by the UE. When the UE fails to receive DCI in the currently assigned BWP for a specific period of time or more, the UE returns to a default BWP and attempts to receive DCI.

### <5G BWP>

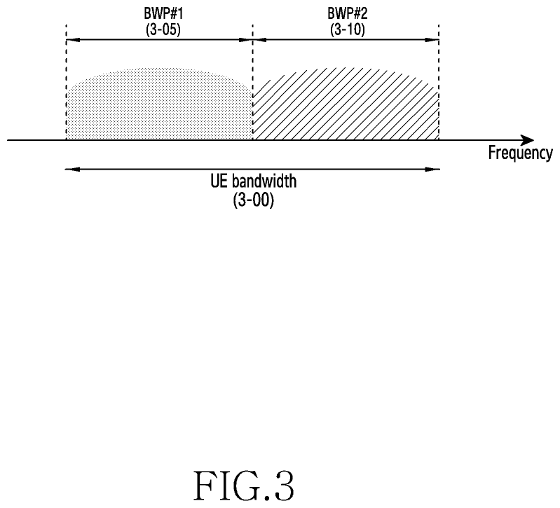

FIG. 3 illustrates a BWP in a wireless communication system according to an embodiment.

Referring to FIG. 3, a UE bandwidth 3-00 is configured to have two BWPs, i.e., BWP #1 3-05 and BWP #2 3-10. A BS may configure one or more BWPs for a UE, and may configure information on each BWP as shown in Table 2 below.

TABLE 2

| | |
|---|---|
| BWP ::= | SEQUENCE { |
| bwp-Id | BWP-Id, |

(Bandwidth part identifier)

| | |
|---|---|
| locationAndBandwidth | INTEGER (1..65536), |

(Bandwidth part location)

| | |
|---|---|
| subcarrierSpacing | ENUMERATED {n0, n1, n2, n3, n4, |

n5},
(Subcarrier spacing)

| | |
|---|---|
| cyclicPrefix | ENUMERATED { extended } |

```
    (Cyclic prefix)
  }
```

Of course, the configuration information is not limited to the example described above. In addition to the configuration information described in Table 2, various parameters related to the BWP may be configured for the UE. The BS may transmit the above information to the UE through higher layer signaling, e.g., RRC signaling. At least one of the one or more configured BWPs may be activated. Information on whether or not to activate the configured BWP may be transmitted from the BS to the UE semi-statically through RRC signaling or dynamically through a MAC control element (CE) or DCI.

For a UE, before an RRC connection, an initial BWP for initial access may be configured by the BS through an MIB. More specifically, in an initial access stage, in order to receive system information (SI) (which may correspond to remaining SI (RMSI) or SI block 1 (SIB1)) for initial access through the MIB, the UE may receive configuration information on a search space and a CORESET through which a physical DL control channel (PDCCH) is transmittable. Each of the CORESET and the search space configured using an MIB may be regarded as having an ID=0.

The BS may notify the UE of configuration information, such as frequency assignment information, time assignment information, numerology, and the like, relating to CORESET #0 through an MIB. In addition, the BS may notify the UE of configuration information on monitoring periodicity and an occasion relating to CORESET #0 (i.e., configuration information on search space #0) through an MIB. The UE may regard the frequency domain configured as CORESET #0 obtained from the MIB, as an initial BWP for initial access. In this case, the ID of the initial BWP may be regarded as 0.

The above-described configuration of the BWP supported by a next-generation mobile communication system (e.g., a 5G or NR system) may be used for various purposes.

For example, in case that the bandwidth supported by a UE is smaller than a system bandwidth, the bandwidth supported by the UE may be supported through configuration of a BWP. For example, in Table 2, a frequency location (configuration information 2) of the BWP may be configured for the UE to allow the UE to transmit and receive data at a specific frequency location within the system bandwidth.

As another example, for the purpose of supporting different numerologies, a BS may configure a plurality of BWPs for a UE. For example, in order to support both transmission and reception of data using a subcarrier spacing of 15 kHz and a SCS of 30 kHz for a certain UE, two BWPs may be configured to use a SCS of 15 kHz and a SCS of 30 kHz, respectively. The different BWPs may be frequency-division-multiplexed (FDMed), and in case that data is to be transmitted or received at a specific SCS, a BWP configured at the corresponding SCS may be activated.

As another example, for the purpose of reducing power consumption of a UE, a BS may configure BWPs having different bandwidths for the UE. For example, if the UE supports a relatively large bandwidth, e.g., a 100 MHz bandwidth, and transmits or receives data always through the large bandwidth, very high-power consumption may be caused. In particular, it is inefficient in terms of power consumption for the UE to monitor unnecessary DL control channels with respect to the large bandwidth of 100 MHz in the absence of traffic. Therefore, the BS may configure a BWP having a relatively small bandwidth, e.g., a 20 MHz BWP, for the UE, in order to reduce the power consumption by the UE. In the absence of traffic, the UE may perform a monitoring operation in the 20 MHz BWP, and, if data is produced, the UE may use the 100 MHz BWP to transmit and receive data, according to the indication of the BS.

In a method of configuring the BWP, UEs, before an RRC connection, may receive configuration information about an initial BWP through an MIB in the initial access stage. More specifically, the UE may receive, from the MIB of a physical broadcast channel (PBCH), a configuration of a CORESET for a DL control channel through which DCI for scheduling an SI block (SIB) can be transmitted. The bandwidth of the control resource set configured through the MIB may be regarded as an initial BWP, and the UE may receive, through the configured initial BWP, a PDSCH through which an SIB is transmitted. The initial BWP may be used for other SI (OSI), paging, and random access, as well as the reception of an SIB.

### <Synchronization Signal Block (SSB)/PBCH>

Hereinafter, an SSB (or an SS/PBCH) of a next-generation mobile communication system (e.g., a 5G or NR system) will be described.

The SSB may indicate a physical layer channel block including a primary synchronization Signal (PSS), a secondary synchronization Signal (SSS), and a PBCH. More specifically, the SSB may be defined as follows.
PSS: A reference signal for DL time/frequency synchronization, which may provide some information of a cell ID.
SSS: A reference for DL time/frequency synchronization, which may provide remaining information of the cell ID, which is not provided by the PSS. Additionally, this may serve as a reference signal for demodulation of a PBCH.

PBCH: May provide essential SI for transmission and reception of a data channel and a control channel of the UE. The essential SI may include search space-related control information indicating radio resource mapping information of the control channel, scheduling control information for a separate data channel transmitting SI, etc.
SSB: An SSB may be configured by a combination of the PSS, the SSS, and the PBCH. One or more SSBs may be transmitted within a time period of 5 ms, and each transmitted SSB may be distinguished by an index.

The UE may detect the PSS and the SSS in the initial access stage, and may decode the PBCH. The UE may acquire an MIB from the PBCH, and may receive a configuration of CORESET #0 through the MIB. The UE may perform monitoring of CORESET #0, based on an assumption that a selected SSB and a demodulation reference signal (DMRS) transmitted in CORESET #0 have a relationship of quasi co-location (QCL). The UE may receive SI through DL control information transmitted from CORESET #0. The UE may obtain configuration information related to a random access channel (RACH) for initial access, from the received SI. The UE may transmit a physical RACH (PRACH) to the BS in consideration of the selected SSB index, and the BS having received the PRACH may obtain information on the SSB index selected by the UE. The BS may recognize which block the UE has selected from among the respective SSBs, and recognize monitoring of CORESET #0 corresponding to (or associated with) the SSB selected by the UE.

### <PDCCH: DCI>

Hereinafter, DCI in a next-generation mobile communication system (e.g., a 5G or NR system) will be described in detail.

In the next-generation mobile communication system, scheduling information on UL data (or a physical UL shared channel (PUSCH)) or DL data (or a PDSCH) may be transmitted from a BS to a UE through DCI. The UE may monitor a DCI format for fallback and a DCI format for non-fallback with respect to a PUSCH or PDSCH. The DCI format for fallback may be configured by fixed fields predefined between the BS and the UE, and the DCI format for non-fallback may include configurable fields.

The DCI may be transmitted through a PDCCH after a channel coding and modulation process. A cyclic redundancy check (CRC) may be attached to the payload of a DCI message, and the CRC may be scrambled by a radio network temporary ID (RNTI) corresponding to the identity of the UE. Different RNTIs may be used for scrambling the CRC attached to the payload of the DCI message according to the purpose of the DCI message, e.g., transmission of UE-specific data, power control command, random access response (RAR), etc. That is, the RNTI may be included in the CRC calculation process and then be transmitted, instead of being explicitly transmitted. When the DCI message transmitted through the PDCCH is received, the UE may check the CRC by using the assigned RNTI. When the CRC check result is correct, the UE may recognize that the message has been transmitted to the UE.

For example, the DCI for scheduling a PDSCH for SI may be scrambled by an SI-RNTI. The DCI for scheduling a PDSCH for an RAR message may be scrambled by a random access (RA)-RNTI. The DCI for scheduling a PDSCH for a paging message may be scrambled by a paging (P)-RNTI. The DCI for transmitting a notification of a slot format indicator (SFI) may be scrambled by an SFI-RNTI. DCI for transmitting a notification of transmit power control (TPC) may be scrambled by a TPC-RNTI. The DCI for scheduling UE-specific PDSCH or PUSCH may be scrambled by a cell-RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include information as shown in Table 3 below.

TABLE 3

- Identifier for DCI formats - [1] bit
- Frequency domain resource assignment -[┌log₂(N_{RB}^{UL, BWP}(N_{RB}^{UL, BWP} + 1)/2)┐ ]

bits

- Time domain resource assignment - X bits
- Frequency hopping flag - 1 bit.
- Modulation and coding scheme - 5 bits
- New data indicator - 1 bit
- Redundancy version - 2 bits
- hybrid automatic repeat request (HARQ) process number - 4 bits
- Transmit power control (TPC) command for scheduled PUSCH - [2] bits
- UL/supplementary UL (UL/SUL) indicator) - 0 or 1 bit

DCI format 0_1 may be used as non-fallback DCI for scheduling a PUSCH, and in this case, the CRC may be scrambled by a C-RNTI. DCI format 0_1, in which the CRC is scrambled by a C-RNTI, may include information as shown in Table 4 below.

TABLE 4

| - | Carrier indicator-0 or 3 bits | |
|---|---|---|
| - | UL/SUL indicator-0 or 1 bit | |
| - | Identifier for DCI formats-[1] bits | |
| - | BWP indicator-0, 1 or 2 bits | |
| - | Frequency domain resource assignment | |
| | • | For resource allocation type 0, ┌N_{RB}^{UL,BWP}/P┐ bits |
| | • | For resource allocation type 1, ┌log₂ ( N_{RB}^{UL,BWP}(N_{RB}^{UL,BWP} + 1)/2)┐ bits |
| - | Time domain resource assignment-1, 2, 3, or 4 bits | |
| - | VRB-to-PRB mapping (Virtual RB-to-physical RB mapping)-0 or 1 bit, only | |
| | for resource allocation type 1. | |
| | • | 0 bit if only resource allocation type 0 is configured; |
| | • | 1 bit otherwise. |
| - | Frequency hopping flag-0 or 1 bit, only for resource allocation type 1. | |
| | • | 0 bit if only resource allocation type 0 is configured; |
| | • | 1 bit otherwise. |
| - | Modulation and coding scheme-5 bits | |
| - | NDI-1 bit | |
| - | RV-2 bits | |
| - | HARQ process number-4 bits | |
| - | 1st DL assignment index-1 or 2 bits | |
| | • | 1 bit for semi-static HARQ-ACK codebook; |
| | • | 2 bits for dynamic HARQ-ACK codebook with single HARQ-ACK |
| | | codebook. |
| - | 2nd DL assignment index-0 or 2 bits | |
| | • | 2 bits for dynamic HARQ-ACK codebook with two HARQ-ACK sub- |
| | | codebooks; |
| | • | 0 bit otherwise. |
| - | TPC command for scheduled PUSCH-2 bits | |
| | | $S R S resource indicator - ⌈ {log}_{2} ( {\sum }_{k = 1}^{{L}_{max} \sum } ( \begin{matrix}{N}_{SRS} \\ k\end{matrix} ) ) ⌉ or ⌈ {log}_{2} ( {N}_{SRS} ) ⌉ bits$ |
| | • | $⌈ {log}_{2} ( {\sum }_{k = 1}^{{L}_{max} \sum } ( \begin{matrix}{N}_{SRS} \\ k\end{matrix} ) ) ⌉ bits for non - codebook based PUSCH$ |
| | | transmission; |
| | • | ┌log₂(N_{SRS})┐ bits for codebook based PUSCH transmission. |

| | |
|---|---|
| - | Precoding information and number of layers-up to 6 bits |
| - | Antenna ports-up to 5 bits |
| - | SRS request-2 bits |
| - | CSI request-0, 1, 2, 3, 4, 5, or 6 bits |
| - | CBG transmission information (Code block group transmission information)- |

0, 2, 4, 6, or 8 bits

| | |
|---|---|
| - | PTRS-DMRS association (Phase tracking reference signal (PTRS)- |

demodulation reference signal (DMRS) association)-0 or 2 bits.

| | |
|---|---|
| - | beta offset indicator (Beta offset indicator)-0 or 2 bits |
| - | DMRS sequence initialization-0 or 1 bit |

DCI format 1_0 may be used as fallback DCI for scheduling a PDSCH, and in this case, the CRC may be scrambled by a C-RNTI. In an embodiment, DCI format 1_0 in which the CRC is scrambled by a C-RNTI may include information as shown in Table 5 below.

TABLE 5
- Identifier for DCI formats - [1] bit
- Frequency domain resource assignment - [┌log₂( N_{RB}^{DL, BWP}(N_{RB}^{DL, BWP} +
1)/2)┐ ] bits
- Time domain resource assignment - X bits
- VRB-to-PRB mapping - 1 bit.
- Modulation and coding scheme - 5 bits
- NDI - 1 bit
- RV - 2 bits
- HARQ process number - 4 bits
- DL assignment index - 2 bits
- TPC command for scheduled PUCCH - [2] bits
- PUCCH resource indicator (Physical UL control channel (PUCCH)
resource indicator - 3 bits
- PDSCH-to-HARQ feedback timing indicator (PDSCH-to-HARQ feedback
timing indicator)- [3] bits

Alternatively, DCI format 1_0 may be used as DCI for scheduling a PDSCH for an RAR message, and in this case, the CRC may be scrambled by an RA-RNTI. DCI format 1_0, in which the CRC is scrambled by a C-RNTI, may include information as shown in Table 6 below.

TABLE 6
- Frequency domain resource assignment - [┌log₂( N_{RB}^{DL, BWP}(N_{RB}^{DL, BWP} + 1)/
2)┐ ] bits
- Time domain resource assignment - 4 bits
- VRB-to-PRB mapping - 1 bit.
- Modulation and coding scheme - 5 bits
- TB scaling - 2 bits
- Reserved bits - 16 bits

DCI format 1_1 may be used as non-fallback DCI for scheduling a PDSCH, and in this case, the CRC may be scrambled by a C-RNTI. DCI format 1_1, in which the CRC is scrambled by a C-RNTI, may include information as shown in Table 7 below.

TABLE 7

| | |
|---|---|
| - | Carrier indicator - 0 or 3 bits |
| - | Identifier for DCI formats - [1] bits |
| - | BWP indicator- 0, 1 or 2 bits |
| - | Frequency domain resource assignment |
| | • For resource allocation type 0, ┌N_{RB}^{UL, BWP}/P┐ bits |
| | • For resource allocation type 1, ┌log₂( N_{RB}^{UL, BWP}(N_{RB}^{UL, BWP} + 1)/2)┐ |
| | bits |
| - | Time domain resource assignment -1, 2, 3, or 4 bits |
| - | VRB-to-PRB mapping (Virtual RB-to-physical RB mapping) - 0 or 1 bit, only |

for resource allocation type 1.

| | |
|---|---|
| | • 0 bit if only resource allocation type 0 is configured; |
| | • 1 bit otherwise. |
| - | PRB(physical resource block) bundling size indicator - 0 or 1 bit |
| - | Rate matching indicator - 0, 1, or 2 bits |
| - | ZP CSI-RS(zero power channel state information reference signal) trigger - 0, |

1, or 2 bits
For transport block 1:

| | |
|---|---|
| - | Modulation and coding scheme - 5 bits |
| - | NDI - 1 bit |
| - | RV - 2 bits |

For transport block 2:

| | |
|---|---|
| - | Modulation and coding scheme - 5 bits |
| - | NDI - 1 bit |
| - | RV - 2 bits |
| - | HARQ process number - 4 bits |
| - | DL assignment index - 0 or 2 or 4 bits |
| - | TPC command for scheduled PUCCH - 2 bits |
| - | PUCCH resource indicator - 3 bits |
| - | PDSCH-to-HARQ feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG(code block group) flushing out information - 0 or 1bit |
| - | DMRS sequence initialization - 1 bit |

### <Regarding QCL Prioritization Rule for PDCCH, PDSCH>

Hereinafter, an operation for determining a QCL priority for a PDCCH is described below.

When a UE operates with carrier aggregation (CA) in a single cell or band and a plurality of CORESETs existing within an activated BWP in a single cell or a plurality of cells temporally overlap each other while having the same or different QCL-TypeD characteristics in a specific PDCCH monitoring occasion, the UE may select a specific CORESET according to a QCL priority determination operation and may monitor CORESETs having the same QCL-TypeD characteristic as that of the corresponding CORESET. For example, when a plurality of CORESETs temporally overlap, only one QCL-TypeD characteristic is allowed to be received. References for determination of the QCL priority may include the following:
Reference 1. CORESET connected to a CSS having a lowest index within a cell corresponding to a lowest index among cells including the CSS.
Reference 2. CORESET connected to a UE-specific search space having a lowest index within a cell corresponding to a lowest index among cells including the UE-specific search space.

As described above, when the corresponding references are not satisfied, the following reference is applied. For example, when CORESETs temporally overlap each other in a specific PDCCH monitoring section, if all CORESETs are connected to a UE-specific search space without being connected to a CSS, i.e., if reference 1 is not satisfied, the UE may omit applying of reference 1 and apply reference 2.

When the CORESET is selected by the references described above, the UE may additionally consider two matters as below for QCL information configured in the CORESET.

First, when CORESET 1 has CSI-RS 1 as a reference signal having the relation of QCL-TypeD, a reference signal for CSI-RS 1 having the relation of QCL-TypeD is SSB1, and a reference signal having the relation of QCL-TypeD with CORESET 2 is SSB1, the UE may consider that two CORESETs 1 and 2 have different QCL-TypeD characteristics.

Second, when CORESET 1 has CSI-RS 1 configured in cell 1 as a reference signal having the relation of QCL-TypeD, a reference signal having the relation of QCL-TypeD with CSI-RS1 is SSB1, CORESET 2 has CSI-RS 2 configured in cell 2 as a reference signal having the relation of QCL-TypeD, and a reference signal having the relation of QCL-TypeD with CSI-RS 2 is SSB 1, the UE may consider that the two CORESETs have the same QCL-TypeD characteristic.

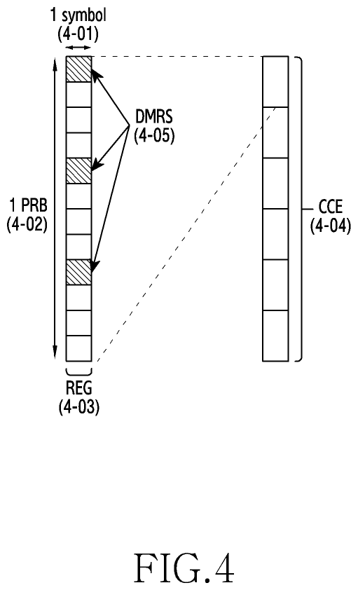

FIG. 4 illustrates a DL control channel in a wireless communication system according to an embodiment. More specifically, FIG. 4 illustrates a basic unit of time and frequency resources constituting a DL control channel usable in a 5G system according to an embodiment.

Referring to FIG. 4, the basic unit of time and frequency resources constituting a control channel may be defined as an RE group (REG) 4-03. The REG 4-03 may be defined as 1 OFDM symbol 4-01 in the time domain and 1 physical RB (PRB) 4-02 in the frequency domain, i.e., 12 subcarriers. The BS may configure a DL control channel allocation unit by concatenating the REGs 4-03.

Assuming that a basic unit to which the DL control channel is allocated in 5G is a control channel element (CCE) 4-04, one CCE 4-04 may include a plurality of REGs 4-03. For example, the REG 4-03 may include 12 REs, and if one CCE 4-04 includes 6 REGs 4-03, one CCE 4-04 may include 72 REs.

Once the DL CORESET is configured, the corresponding area may include a plurality of CCEs 4-04, and a specific DL control channel may be transmitted after being mapped to one or more CCEs 4-04 according to the aggregation level (AL) in the CORESET. The CCEs 4-04 in the CORESET are identified by numbers, and the numbers of the CCEs 4-04 may be assigned according to a logical mapping method.

The basic unit of the DL control channel shown in FIG. 4, i.e., the REG 4-03, may include both the REs to which the DCI is mapped and an area to which the DMRS 4-05, which is a reference signal for decoding the same, is mapped.

As illustrated in FIG. 4, three DMRSs 4-05 may be transmitted in 1 REG 4-03. The number of CCEs required for transmitting the PDCCH may be 1, 2, 4, 8, or 16 depending on the AL, and the different numbers of CCEs may be used to implement link adaptation of the DL control channel. For example, when AL=L, one DL control channel may be transmitted through L CCEs.

The UE should detect a signal without being aware of information about the DL control channel, and a search space indicating a set of CCEs may be defined for blind decoding. The search space is a set of DL control channel candidates including CCEs that the UE should attempt to decode in a given AL. Since there are various ALs making one bundle of 1, 2, 4, 8, or 16 CCEs, the UE may have a plurality of search spaces. The search space set may be defined as a set of search spaces in all configured ALs.

The search spaces may be classified into a CSS and a UE-specific search space. A specific group of UEs or all UEs may check a CSS of the PDCCH in order to receive cell-common control information such as dynamic scheduling for system information or a paging message.

For example, the UE may receive PDSCH scheduling allocation information for transmission of an SIB including cell operator information and the like by examining the CSS of the PDCCH. In the case of the CSS, since a specific group of UEs or all UEs should receive the PDCCH, the CSS may be defined as a set of predetermined CCEs. The UE may receive scheduling allocation information for a UE-specific PDSCH or PUSCH by inspecting the UE-specific search space of the PDCCH. The UE-specific search space may be UE-specifically defined as a function of the UE identity and various system parameters.

In 5G, the parameters of the search space for the PDCCH may be configured for the UE by the BS using higher layer signaling (e.g., SIB, MIB, or RRC signaling). The BS may configure the number of PDCCH candidates in each aggregation level L, monitoring periodicity for the search space, a monitoring occasion in units of symbols within the slot for the search space, the search space type (the CSS or the UE-specific search space), a combination of the DCI format and the RNTI to be monitored in the search space, the CORESET index for monitoring the search space, etc., for the UE.

For example, the above-described configuration may include information as shown in Table 8 below.

TABLE 8

| | |
|---|---|
| SearchSpace ::= | SEQUENCE { |

```
  -- Identity of the search space. SearchSpaceId = 0 identifies the SearchSpace configured via PBCH
  (MIB) or ServingCellConfigCommon.
```

| | |
|---|---|
| searchSpaceId | SearchSpaceId, |

(Search space identifier)

| | |
|---|---|
| controlResourceSetId | ControlResourceSetId, |

(Control area identifier)

| | |
|---|---|
| monitoringSlotPeriodicityAndOffset | CHOICE { |

```
      (Monitoring slot level cycle)
          sl1
          NULL
          sl2
          INTEGER (0..1),
          s14
          INTEGER (0..3),
          sl5
          INTEGER (0..4),
          sl8
          INTEGER (0..7),
          sl10
          INTEGER (0..9),
          sl16
          INTEGER (0..15),
          sl20
          INTEGER (0..19)
  }
```

OPTIONAL,

| | |
|---|---|
| duration (Monitoring duration) | INTEGER (2..2559) |

| | |
|---|---|
| monitoringSymbolsWithinSlot | BIT STRING (SIZE |

(14))

OPTIONAL,

(Monitoring symbol in slot )

| | |
|---|---|
| nrofCandidates | SEQUENCE { |

(Number of candidate PDCCHs at each AL )

| | |
|---|---|
| aggregationLevel1 | ENUMERATED {n0, |

n1, n2, n3, n4, n5, n6, n8},

| | |
|---|---|
| aggregationLevel2 | ENUMERATED {n0, |

n1, n2, n3, n4, n5, n6, n8},

| | |
|---|---|
| aggregationLevel4 | ENUMERATED {n0, |

n1, n2, n3, n4, n5, n6, n8},

| | |
|---|---|
| aggregationLevel8 | ENUMERATED {n0, |

n1, n2, n3, n4, n5, n6, n8},

| | |
|---|---|
| aggregationLevel16 | ENUMERATED {n0, |

```
          n1, n2, n3, n4, n5, n6, n8}
          },
```

| | |
|---|---|
| searchSpaceType | CHOICE { |

```
              (Search space type)
                  -- Configures this search space as common search space (CSS) and DCI formats to monitor.
                  common
                  SEQUENCE {
          (Common search space)
                }
                  ue-Specific
                  SEQUENCE {
            (UE-specific search space)
                    -- Indicates whether the UE monitors in this USS for DCI formats 0-0 and 1-0 or for
          formats 0-1 and 1-1.
                    formats
                  ENUMERATED {format0-0-And-1-0, formats0-1-And-1-1},
                    ...
                  }
```

The BS may configure one or more search space sets for the UE, based on configuration information. The BS may configure search space set 1 and search space set 2 for the UE, may configure DCI format A scrambled by an X-RNTI in search space set 1 so as to be monitored in the CSS, and may configure DCI format B scrambled by a Y-RNTI in the search space set 2 so as to be monitored in the UE-specific search space.

According to configuration information, the CSS or the UE-specific search space may include one or a plurality of search space sets. For example, search space set #1 and search space set #2 may be configured as the CSS, and search space set #3 and search space set #4 may be configured as the UE-specific search space.

The CSS may be classified into a specific type of search space set according to the purpose thereof. The RNTI to be monitored may differ between the determined types of search space sets. For example, the CSS types, the purposes, and the RNTIs to be monitored may be classified as shown in Table 9 below.

TABLE 9

| Search space | | |
|---|---|---|
| type | Purposes | RNTI |
| Type0 CSS | PDCCH transmission for | SI-RNTI |
| | scheduling of SIB | |
| Type0A CSS | PDCCH transmission for | SI-RNTI |
| | scheduling of SI other | |
| | than SIB1 (SIB2 or the like) | |
| Type1 CSS | PDCCH transmission for | RA-RNTI, |
| | scheduling of RAR, | TC-RNTI |
| | scheduling of Msg3 | |
| | retransmission, and | |
| | scheduling of Msg4 | |
| Type2 CSS | Paging | P-RNTI |
| Type3 CSS | Transmission of group | INT-RNTI, |
| | control information | SFI-RNTI, |
| | | TPC-PUSCH-RNTI, |
| | | TPC-PUCCH-RNTI, |
| | | TPC-SRS-RNTI |
| | PDCCH transmission for | C-RNTI, |
| | scheduling of data for PCell | MCS-C-RNTI, |
| | | CS-RNTI |

The following combinations of DCI formats and RNTIs may be monitored in the CSS. However, the disclosure is not limited to the following examples.
DCI format 0_0/1_0 with CRC scrambled by C-RNTI, CS-RNTI, SP-CSI-RNTI, RA-RNTI, TC-RNTI, P-RNTI, and SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI and TPC-PUCCH-RNTI
DCI format 2_3 with CRC scrambled by TPC-SRS-RNTI

In the UE-specific search space, the following combinations of DCI formats and RNTIs may be monitored. However, the disclosure is not limited to the following examples.
DCI format 0_0/1_0 with CRC scrambled by C-RNTI, CS-RNTI, and TC-RNTI
DCI format 1_0/1_1 with CRC scrambled by C-RNTI, CS-RNTI, and TC-RNTI

The specified RNTIs may follow the definitions and usages as follows.
C-RNTI for scheduling of UE-specific PDSCH
Temporary cell RNTI (TC-RNTI) for scheduling of UE-specific PDSCH
Configured scheduling RNTI (CS-RNTI) for scheduling of semi-statically configured UE-specific PDSCH
RA-RNTI for scheduling of PDSCH in random access stage
P-RNTI for scheduling of PDSCH in which paging is transmitted
SI-RNTI for scheduling of PDSCH in which SI is transmitted
Interruption RNTI (INT-RNTI) for informing of puncturing on PDSCH
TPC for PUSCH RNTI (TPC-PUSCH-RNTI) for indicating power control command for PUSCH
TPC for PUCCH RNTI (TPC-PUCCH-RNTI) for indicating power control command for PUCCH
TPC for SRS RNTI (TPC-SRS-RNTI) for indicating power control command for SRS

The above-described DCI formats may be defined as shown in Table 10 below.

TABLE 10

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the |
| | slot format |
| 2_1 | Notifying a group of UEs of the |
| | PRB(s) and OFDM symbol(s) where |
| | UE may assume no transmission is |
| | intended for the UE |
| 2_2 | Transmission of TPC commands for |
| | PUCCH and PUSCH |
| 2_3 | Transmission of a group of TPC |
| | commands for SRS transmissions |
| | by one or more UEs |

A plurality of search space sets may be configured using different parameters (e.g., the parameters in Table 8) in 5G. Therefore, a set of search space sets monitored by the UE may differ each time. For example, in case that search space set #1 is configured as the X-slot periodicity, if search space set #2 is configured to have the Y-slot periodicity, and if X and Y are different, the UE may monitor both search space set #1 and search space set #2 in a specific slot, and may monitor one of search space set #1 and search space set #2 in a specific slot.

If a plurality of search space sets is configured for the UE, the following conditions may be considered in order to determine the search space set to be monitored by the UE.

### [Condition 1: Limit Maximum Number of PDCCH Candidates]

The number of PDCCH candidates capable of being monitored per slot may not exceed Mu. Mu may be defined as the maximum number of PDCCH candidates per slot in the cell in which the SCS is configured to be 15·2μ kHz, and may be defined as shown in Table 11 below.

TABLE 11

| | Maximum number of PDCCH candidates |
|---|---|
| μ | per slot and per serving cell (M^{μ}) |
| 0 | 44 |
| 1 | 36 |
| 2 | 22 |
| 3 | 20 |

### [Condition 2: Limit Maximum Number of CCEs]

The number of CCEs constituting the entire search space per slot (i.e., the entire search space may indicate a set of all CCEs corresponding to the union area of a plurality of search space sets) may not exceed Cu. Cu may be defined as the maximum number of CCEs per slot in the cell in which the SCS is configured to be 15·2μ kHz, and may be defined as shown in Table 12 below.

TABLE 12

| | Maximum number of CCEs per |
|---|---|
| μ | slot and per serving cell(C^{μ}) |
| 0 | 56 |
| 1 | 56 |
| 2 | 48 |
| 3 | 32 |

For convenience of explanation, the situation in which both condition 1 and condition 2 are satisfied at a specific time may be defined as “condition A.” Therefore, a case in which condition A is not satisfied may indicate a case in which at least one of condition 1 and condition 2 described above is not satisfied.

Condition A may not be satisfied at a specific time depending on the configurations of the search space sets of the BS. If condition A is not satisfied at a specific time, the UE may select and monitor only some of the search space sets configured to satisfy condition A at the corresponding time, and the BS may transmit a PDCCH to the selected search space set.

According to an embodiment, selection of some search spaces from among the overall configured search space sets may be performed according to the following methods.

### [Method 1]

In case that condition A for the PDCCH is not satisfied at a specific time (i.e., slot), a UE (or a BS) may preferentially select the search space set in which the search space type is configured as a CSS from among the search space sets existing at the corresponding time, instead of the search space set in which the search space type is configured as a UE-specific search space.

In case that all search space sets configured as the CSS are selected (i.e., if condition A is satisfied even after selecting all search spaces configured as the CSS), the UE (or the BS) may select the search space sets configured as the UE-specific search space. In case that there are a plurality of search space sets configured as the UE-specific search space, the search space set having a lower search space set index may have a higher priority. The UE or the BS may select the UE-specific search space sets within a range in which condition A is satisfied in consideration of priority.

Hereinafter, methods for allocating time and frequency resources for transmission of data in NR will be described.

The NR system may provide detailed frequency domain resource allocation (FD-RA) methods as follows, in addition to frequency domain resource candidate allocation through BWP indication.

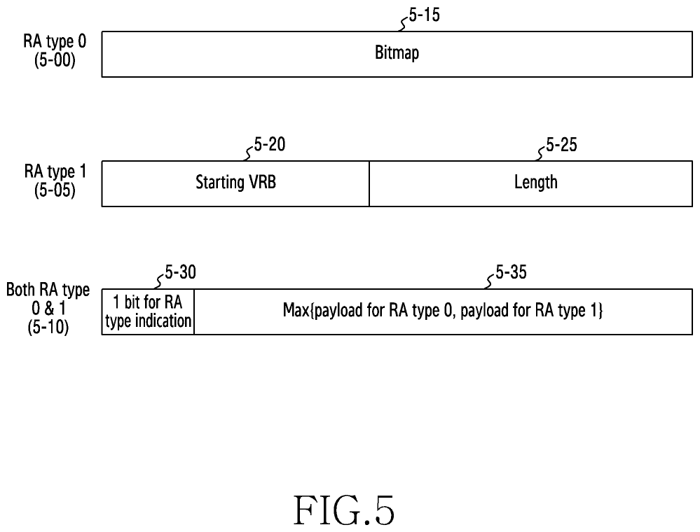

FIG. 5 illustrates allocation of frequency-domain resources of a PDSCH in a wireless communication system according to an embodiment.

More specifically, FIG. 5 illustrates three FD-RA methods of type 0 (5-00), type 1 (5-05), and dynamic switch 5-10, which may be configured through a higher layer in NR.

Referring to FIG. 5, in case that a UE is configured to use only resource type 0 through higher layer signaling (indicated by reference numeral 5-00), some DCI for allocating a PDSCH to the UE has a bitmap configured by a number of RB groups (RBGs) (NRBG) bits. The NRBG may be determined, as shown in Table 13 below, according to the size of a BWP allocated by a BWP indicator and the higher layer parameter “rbg-Size”, and data is transmitted to the RBG represented as “1” using a bitmap.

TABLE 13

| Bandwidth | | |
|---|---|---|
| Part Size | Configuration 1 | Configuration 2 |
| 1-36 | 2 | 4 |
| 37-72 | 4 | 8 |
| 73-144 | 8 | 16 |
| 145-275 | 16 | 16 |

In case that the UE is configured to use only resource type 1 through higher layer signaling (indicated by reference numeral 5-05), some DCI for allocating PDSCHs to the UE has FD-RA information including ┌log₂(N_{RB}^{DL,BWP} (N_{RB}^{DL,BWP}+1)/2)┐ bits. The BS may configure starting VRB 5-20 and the length 5-25 of the frequency domain resource consecutively allocated thereafter.

If the UE is configured to use both resource type 0 and resource type 1 through higher layer signaling (indicated by reference numeral 5-10), some DCI for allocating the PDSCHs to the corresponding UE has frequency domain resource allocation information including bits of a large value 5-35 among the payload 5-15 for configuring resource type 0 and the payloads 5-20 and 5-25 for configuring resource type 1. The conditions for this will be described again later. In this case, one bit may be added to the foremost part (i.e., most significant bits (MSB)) of the FD-RA information in the DCI, and bit 0 indicates that resource type 0 is to be used, and bit 1 indicates that resource type 1 is to be used.

Hereinafter, a time domain resource allocation method for a data channel in the next-generation mobile communication system (e.g., a 5G or NR system) will be described.

The BS may configure a table about time domain resource allocation information for a DL data channel (e.g., a PDSCH) and a UL data channel (e.g., a PUSCH) for the UE through higher layer signaling (e.g., RRC signaling). A table including up to maxNrofDL-Allocations=16 entries may be configured for the PDSCH, and a table including up to maxNrofUL-Allocations=16 entries may be configured for the PUSCH. The time domain resource allocation information may include PDCCH-to-PDSCH slot timing (corresponding to the time interval in units of slots between the time at which the PDCCH is received and the time at which the PDSCH scheduled by the received PDCCH is transmitted, which is denoted as K0), PDCCH-to-PUSCH slot timing (corresponding to the time interval in units of slots between the time at which the PDCCH is received and the time at which the PUSCH scheduled by the received PDCCH is transmitted, which is denoted as K2), information on the location and length of a start symbol in which the PDSCH or PUSCH is scheduled in the slot, a mapping type of the PDSCH or PUSCH, and the like.

For example, the BS may notify the UE of the information shown in Table 14 or Table 15 below.

TABLE 14
PDSCH-TimeDomainResourceAllocationList information element

| | |
|---|---|
| PDSCH-TimeDomainResourceAllocationList | ::= SEQUENCE (SIZE(1..maxNrofDL-Allocations)) OF |

PDSCH-TimeDomainResourceAllocation

| | |
|---|---|
| PDSCH-TimeDomainResourceAllocation ::= | SEQUENCE { |

| | |
|---|---|
| k0 | INTEGER (0..32) |

OPTIONAL, -- Need S
(PDCCH-to-PDSCH Timing, slot unit )

| | |
|---|---|
| mappingType | ENUMERATED (typeA, typeB), |

{PDSCH Mapping type}

| | |
|---|---|
| startSymbolAndLength | INTEGER (0..127) |

{Start symbol and length of PDSCH}
}

TABLE 15
PUSCH-TimeDomainResourceAllocation information element

PUSCH-TimeDomainResourceAllocationList ::= SEQUENCE (SIZE(1..maxNrofUL-Allocations)) OF
PUSCH-TimeDomainResourceAllocation

| PUSCH-TimeDomainResourceAllocation ::= | SEQUENCE { | |
|---|---|---|
| k2 | INTEGER(0 .. 32) | OPTIONAL, -- Need S |

(PDCCH-to-PUSCH Timing, slot unit )

| | |
|---|---|
| mappingType | ENUMERATED (typeA, typeB), |

{PUSCH Mapping type}

| | |
|---|---|
| startSymbolAndLength | INTEGER (0..127) |

{Start symbol and length of PUSCH}
}

The BS may notify the UE of one of the entries in the table for the time domain resource allocation information described above through L1 signaling (e.g., DCI) (e.g., it may be indicated by a field “time domain resource allocation” in DCI). The UE may obtain time domain resource allocation information for the PDSCH or the PUSCH, based on the DCI received from the BS.

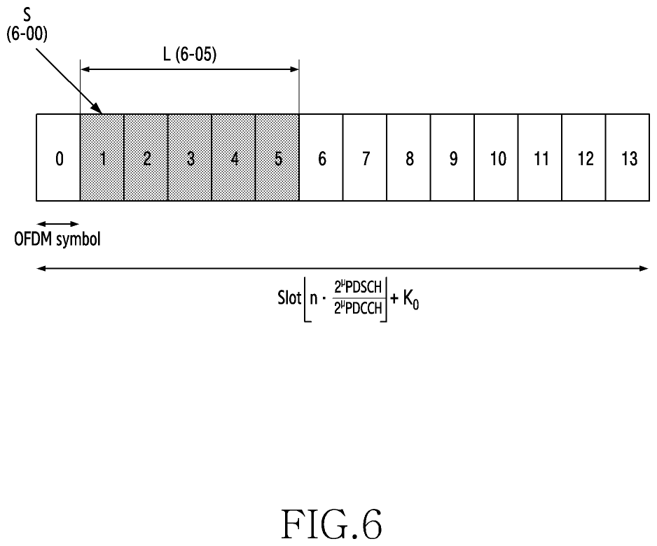

FIG. 6 illustrates allocation of time domain resources of a PDSCH in a wireless communication system according to an embodiment.

Referring to FIG. 6, a BS may indicate the time domain location of a PDSCH resource according to the SCS (μ_{PDSCH}, μ_{PDCCH}) of a data channel and a control channel configured using a higher layer, a slot offset value (K0), a starting location 6-00 of OFDM symbols within one slot dynamically indicated through DCI, and the length 6-05 thereof.

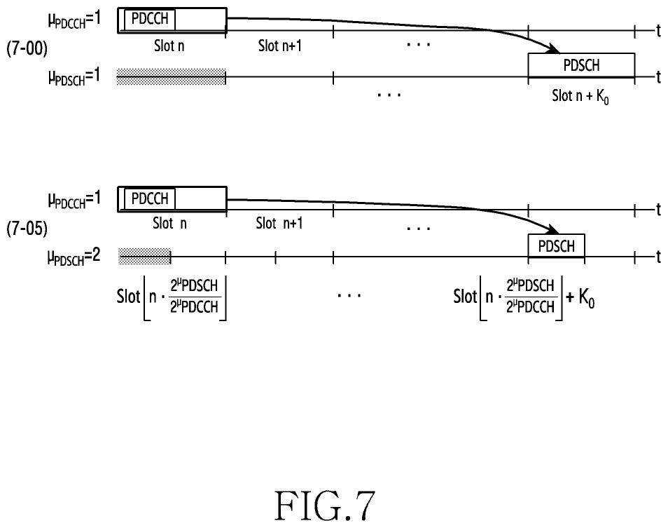

FIG. 7 illustrates allocation of time domain resources according to SCS of a data channel and a control channel in a wireless communication system according to an embodiment.

Referring to FIG. 7, when the SCS of the data channel is the same as the SCS of the control channel (μ_{PDSCH}=μ_{PDCCH}) (7-00), the slot numbers for the data and the control are the same. Accordingly, the BS and the UE may recognize the occurrence of a scheduling offset according to a predetermined slot offset (K0). On the other hand, when the SCS of the data channel is different from the SCS of the control channel (μ_{PDSCH}≠μ_{PDCCH}) (7-05), the slot numbers for the data and the control are different from each other. Accordingly, the BS and the UE may recognize the occurrence of a scheduling offset according to a predetermined slot offset (K0), based on the SCS of the PDCCH.

### <QCL, TCI State>

In a wireless communication system, one or more different antenna ports (which are replaceable with one or more channels, signals, and combinations thereof, but are uniformly referred to as different antenna ports for convenience in the following description of the disclosure) may be associated by a QCL configuration shown in Table 16 below. The TCI state is to notify of a QCL relation between a PDCCH (or a PDCCH DMRS) and another RS or channel, and an expression “a reference antenna port A (reference RS #A) and another purpose antenna port B (target RS #B) are QCLed” means that the UE is allowed to apply some or all of large-scale channel parameters estimated in the antenna port A to channel measurement from the antenna port B. The QCL is required to associate different parameters, such as 1) time tracking influenced by average delay and delay spread, 2) frequency tracking influenced by Doppler shift and Doppler spread, 3) radio resource management (RRM) influenced by an average gain, and 4) beam management (BM) influenced by a spatial parameter, according to situations. Accordingly, NR supports four types of QCL relations shown in Table 16 below.

TABLE 16

| QCL | |
|---|---|
| type | Large-scale characteristics |
| A | Doppler shift, Doppler spread, |
| | average delay, delay spread |
| B | Doppler shift, Doppler spread |
| C | Doppler shift, average delay |
| D | Spatial Rx parameter |

The spatial RX parameter may refer to some or all of various parameters, such as angle of arrival (AoA), power angular spectrum (PAS) of AoA, angle of departure (AoD), PAS of AoD, transmit/receive channel correlation, transmit/receive beamforming, spatial channel correlation, etc.

The QCL relation may be configured in the UE through RRC parameter TCI-state and QCL-Info as shown in Table 17 below.

Referring to Table 17 below, the BS may configure one or more TCI states in the UE and inform the UE of a maximum of two QCL relations (qcl-Type 1 and qcl-Type 2) for a RS referring to IDs of the TCI states, that is, a target RS. Each piece of the QCL information (QCL-Info) included in the TCI state includes a serving cell index and a BWP index of a reference RS indicated by the corresponding QCL information, a type and an ID of the reference RS, and the QCL type as shown in Table 16 above.

TABLE 17

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first reference RS of RS (target RS) referring
to corresponding TCI sate ID)

| | |
|---|---|
| qcl-Type2 | QCL-Info OPTIONAL, -- Need R |

```
    (QCL information of second reference RS of RS (target RS) referring
to corresponding TCI sate ID)
    ...
  }
```

| QCL-Info ::= | SEQUENCE { | |
|---|---|---|
| cell | ServCellIndex | OPTIONAL, -- |

Need R
(Serving cell index of reference RS indicated by corresponding QCL
information)

| | |
|---|---|
| bwp-Id | BWP-Id |

```
  OPTIONAL, -- Cond CSI-RS-Indicated
    (BWP index of reference RS indicated by corresponding QCL
information)
```

| | |
|---|---|
| referenceSignal | CHOICE { |
| csi-rs | NZP-CSI-RS-ResourceId, |
| ssb | SSB-Index |

```
      (One of CSI-RS and SSB ID indicated by corresponding QCL
information)
    },
```

| | |
|---|---|
| qcl-Type | ENUMERATED {typeA, typeB, typeC, |

```
typeD},
    ...
  }
```

### <Method and Apparatus for HARQ-ACK Feedback Transmission>

An NR system employs a hybrid automatic repeat request (HARQ) scheme for, when a decoding failure has occurred in an initial transmission, retransmitting corresponding data in a physical layer. The HARQ scheme includes, if a receiver fails to correctly decode data, the receiver transmits information (negative acknowledgement (NACK)) notifying of a decoding failure to a transmitter, so as to allow the transmitter to retransmit corresponding data in a physical layer. The receiver combines the data retransmitted by the transmitter with the data that previously failed to be decoded, to improve data reception performance. In addition, when the receiver correctly decodes data, the receiver may transmit information (acknowledgement (ACK) notifying of a decoding success to the transmitter, so as to allow the transmitter to transmit new data.

Hereinafter, a method and apparatus for transmitting HARQ-ACK feedback for DL data transmission are described. Specifically, a method for configuring HARQ-ACK feedback bits when a UE is to transmit multiple HARQ-ACKs within a slot through a UL is described.

In a wireless communication system, e.g., an NR system, a BS may configure one CC or multiple CCs for DL transmission to a UE. Further, in each CC, DL transmission and UL transmission slots and symbols may be configured. When a PDSCH, which is DL data, is scheduled, at least one of slot timing information for PDSCH mapping, position information on a start symbol for PDSCH mapping in the corresponding slot, or information on the number of symbols mapped by the PDSCH may be transmitted through a specific bit field of DCI. For example, when the DCI is transmitted while scheduling the PDSCH in slot n, and if K0 which is slot timing information for PDSCH transmission indicates 0, a start symbol position is 0, and a symbol length is 7, the PDSCH is transmitted after being mapped to seven symbols from symbol 0 in slot n.

After K1 slot from transmission of a PDSCH, which is a DL data signal, the HARQ-ACK feedback is transmitted from the UE to the BS. K1 information, which is timing information for HARQ-ACK transmission, may be transmitted through the DCI, a candidate set of possible K1 values may be delivered via higher signaling, and the DCI may indicate one of them.

When a semi-static HARQ-ACK codebook is configured for a UE, the UE may determine the feedback bit (or HARQ-ACK codebook size) to be transmitted, based on a table including slot information K0, start symbol information, the number of symbols, and length information, in relation to PDSCH mapping, and based on K1 candidate values which are HARQ-ACK feedback timing information for PDSCH. The table including slot information, start symbol information, the number of symbols, and length information, in relation to PDSCH mapping, may have default values or may be configured in the UE by the BS.

In case that a dynamic HARQ-ACK codebook is configured for a UE, the UE may determine the HARQ-ACK feedback bit (or HARQ-ACK codebook size) to be transmitted by the UE, based on DL assignment indicator (DAI) information included in the DCI in a slot for transmission of HARQ-ACK information determined according to slot information K0 for PDSCH mapping and HARQ-ACK feedback timing information K1 value for PDSCH.

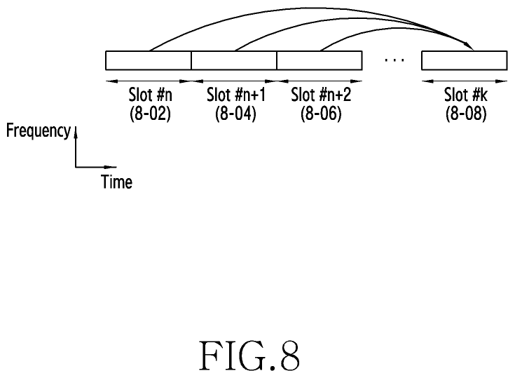

FIG. 8 illustrates a method for configuring a semi-static HARQ-ACK codebook in an NR system according to an embodiment.

In a situation in which the number of HARQ-ACK PUCCHs that a UE can transmit in one slot is limited to one, when a higher layer signal configuring a semi-static HARQ-ACK codebook is received by the UE, the UE may receive a PDSCH in a HARQ-ACK codebook in a slot indicated by the value of a PDSCH-to-HARQ feedback timing indicator in a DCI format 1_0 or a DCI format 1_1, or may report HARQ-ACK information for semi-persistent scheduling (SPS) PDSCH release in the slot. The UE may report a HARQ-ACK information bit value, through a NACK, in a HARQ-ACK codebook in a slot that is not indicated by a PDSCH-to-HARQ feedback timing indicator field in a DCI format 1_0 or a DCI format 1_1. When the UE reports only HARQ-ACK information for one SPS PDSCH release or one PDSCH reception in MA,c cases for candidate PDSCH reception, and the report is scheduled by a DCI format 1_0 including information indicating that a counter DCI field is 1 in a Pcell, the UE may determine one HARQ-ACK codebook for the SPS PDSCH release or the PDSCH reception.

Other than the above case, a HARQ-ACK codebook determination method according to the methods described below may be employed.

When a set of PDSCH reception candidate occasions in serving cell c is MA,c, MA,c may be obtained through the [pseudo-code 1] stages below.

[pseudo-code 1 start]
stage 1: initializing j to 0, and initializing M_A,c to an empty set. Initializing k, which is a HARQ-ACK transmission timing index, to 0.
stage 2: configuring R as a set of rows of a table including information of a slot to which a PDSCH is mapped, starting symbol information, and information of the number or length of symbols. When a PDSCH-available mapping symbol indicated by a value of R according to DL and UL configurations configured through higher signaling, removing a corresponding row from R is configured as a UL symbol.
stage 3-1: a UE may receive one unicast PDSCH in one slot, and when R is not an empty set, one PDSCH is added to set M_A,c.
stage 3-2: if the UE is able to receive two or more unicast PDSCHs in one slot, counting the number of PDSCHs allocatable in different symbols from the calculated R, and adding the counted number of PDSCHs to MA,c.
stage 4: increasing k by one and restarting from stage 2.
   [pseudo-code 1 end]

Hereinafter, pseudo-code 1 is described with reference to FIG. 8.

Referring to FIG. 8, in order to transmit a HARQ-ACK PUCCH in slot #k 8-08, a UE may consider all slot candidates in which a PDSCH-to-HARQ-ACK timing capable of indicating slot #k 8-08 is possible. In FIG. 8, it is assumed that HARQ-ACK transmission is possible in slot #k 8-08 by a combination of PDSCH-to-HARQ-ACK timings that are possible by only PDSCHs scheduled in slot #n 8-02, slot #(n+1) 8-04, and slot #(n+2) 8-06. By considering time domain resource configuration information of a PDSCH which can be scheduled in each of the slots 8-02, 8-04, and 8-06, and information indicating whether a symbol in a slot corresponds to the UL or the DL, the number of PDSCHs which can be maximally scheduled for each slot is derived. For example, when two PDSCHs can be maximally scheduled in the slot 8-02, three PDSCHs can be maximally scheduled in the slot 8-04, and two PDSCHs can be maximally scheduled in the slot 8-06, respectively, the maximum number of PDSCHs included in a HARQ-ACK codebook transmitted in the slot 8-08 is 7. This is called the cardinality of an HARQ-ACK codebook.

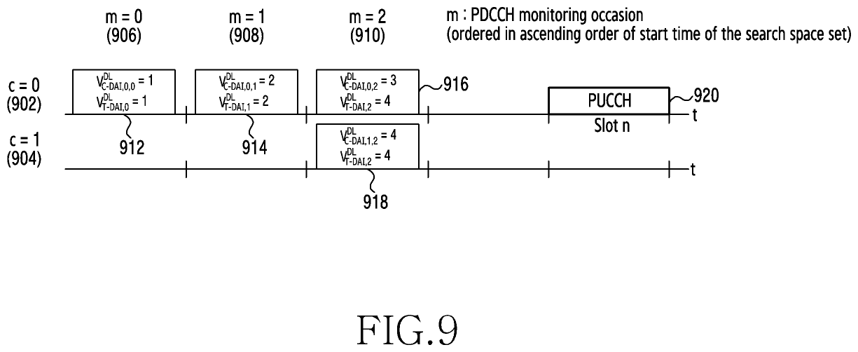

FIG. 9 illustrates a method of configuring a dynamic HARQ-ACK codebook in an NR system according to an embodiment.

A UE may transmit HARQ-ACK information transmitted in one PUCCH in slot n, based on a PDSCH-to-HARQ feedback timing value for PUCCH transmission of HARQ-ACK information for PDSCH reception or SPS PDSCH release, and a K0 that is transmission slot position information of a PDSCH scheduled by a DCI format 1_0 or 1_1.

Specifically, for the above HARQ-ACK information transmission, the UE may determine an HARQ-ACK codebook of a PUCCH transmitted in a slot determined by a PDSCH-to-HARQ feedback timing and K0, based on a DAI included in DCI indicating a PDSCH or SPS PDSCH release.

The DAI is configured by a counter DAI (C-DAI) and a total DAI (T-DAI). The C-DAI is information indicating the position of HARQ-ACK information in a HARQ-ACK codebook, which corresponds to a PDSCH scheduled by a DCI format 1_0 or a DCI format 1_1. Specifically, a C-DAI value in a DCI format 1_0 or 1_1 indicates the accumulative value of PDSCH receptions or SPS PDSCH releases scheduled by the DCI format 1_0 or 1_1 in particular cell c. The above accumulative value is configured based on a PDCCH monitoring occasion in which the scheduled DCI exists and a serving cell.

The T-DAI is a value indicating the size of a HARQ-ACK codebook. Specifically, a T-DAI value implies the total number of PDSCHs or SPS PDSCH releases which are scheduled at and before the time point at which DCI is scheduled. Further, a T-DAI is a parameter used in a case where, in a CA situation, HARQ-ACK information in serving cell c also includes HARQ-ACK information for a PDSCH scheduled in another cell as well as serving cell c. In other words, there is no T-DAI parameter in a system operated by one cell.

FIG. 9 illustrates a UE operation relating to the DAI in case that the dynamic HARQ-ACK codebook is used.

Referring to FIG. 9, in a case in which two carriers (c) are configured for a UE, when the UE transmits an HARQ-ACK codebook selected based on a DAI, through a PUCCH 920 in an n-th slot of carrier 0 902, the values of a C-DAI and a T-DAI indicated by DCI discovered in each PDCCH monitoring occasion configured for each of the carriers are changed.

First, in DCI discovered in an occasion of m=0 (as indicated by reference numeral 906), each of the C-DAI and the T-DAI indicates 1 (as indicated by reference numeral 912). In DCI discovered in an occasion of m=1 (as indicated by reference numeral 908), each of the C-DAI and the T-DAI indicates 2 (as indicated by reference numeral 914). In DCI discovered in carrier 0 (c=0, 902) in an occasion of m=2 (as indicated by reference numeral 910), the C-DAI indicates 3 (as indicated by reference numeral 916). In DCI discovered in carrier 1 (c=1, 904) in the occasion of m=2 (as indicated by reference numeral 910), the C-DAI indicates 4 (as indicated by reference numeral 918). If carriers 0 and 1 are scheduled in the same monitoring occasion, all the T-DAIs are indicated by 4.

As illustrated in FIGS. 8 and 9, the determination of a HARQ-ACK codebook may be performed on an assumption that only one PUCCH containing HARQ-ACK information is transmitted in one slot. As an example of a method in which one PUCCH transmission resource is determined in one slot, when PDSCHs scheduled in different pieces of DCI are multiplexed into one HARQ-ACK codebook in the same slot and the codebook is then transmitted, a PUCCH resource selected for HARQ-ACK transmission may be determined to be a PUCCH resource indicated by a PUCCH resource field indicated in DCI having lastly scheduled a PDSCH. That is, a PUCCH resource indicated by a PUCCH resource field indicated in DCI scheduled before the DCI is neglected.

### <Unlicensed Band>

For a system that performs communication in an unlicensed band, a communication device (i.e., a BS or a terminal) that is to transmit a signal via an unlicensed band may perform, before signal transmission, a CAP, listen-before-talk (LBT), or channel sensing with respect to the unlicensed band in which communication is to be performed, and when the unlicensed band is determined to be idle according to the CAP, the communication device may access the unlicensed band to perform signal transmission. If the unlicensed band is determined not to be idle according to the performed CAP, the communication device may not perform signal transmission. Here, the CAP is a procedure in which a BS or a terminal occupies a channel for a fixed (deterministic) time or a randomly determined time to measure a strength of a signal received through the channel that is for signal transmission, and may compare the measured signal strength with a predefined threshold or threshold X_{Thresh}, which is calculated by a function, a value of which is determined using at least one variable among a channel bandwidth, a bandwidth of a signal, in which a signal to be transmitted is transmitted, and/or a strength of transmission power.

If the strength of the received signal, which is measured via sensing for the unlicensed band channel is less than X_{Thresh}, the BS and the terminal may determine that the channel is idle or that the channel may be used (or occupied), and may occupy and use the channel. If a result of the sensing is equal to or greater than X_{Thresh}, the BS and the terminal may determine that the channel is busy or determine that the channel cannot be used (or occupied), and therefore the BS and the terminal may not use the channel. In this case, the BS and terminal may continuously perform sensing until the channel is determined to be idle. In other words, the CAP in the unlicensed band may refer to a procedure of assessing, based on sensing, the possibility of performing transmission in the channel. A basic unit of sensing is a sensing slot, which may be a duration of Tₛₗ=9 μs. In this case, when power detected in at least 4 us in the sensing slot duration is less than X_{Thresh}, the sensing slot duration may be considered to be idle or not in use (idle). If the power detected in at least 4 us in the sensing slot duration is equal to or greater than X_{Thresh}, the sensing slot duration may be considered to be busy or used by another device.

The CAP in the unlicensed band may be classified depending on whether an initiation time point of the CAP of the communication device is fixed (frame-based equipment (FBE)) (or semi-static) or variable (load-based equipment (LBE)) (or dynamic). In addition to the initiation time point of the CAP, the communication device may be determined to be an FBE device or an LBE device depending on whether a transmission/reception structure of the communication device has one period or does not have one period. Here, the fact that the initiation time point of the CAP is fixed may indicate that the CAP of the communication device may be started periodically according to a predefined declaration or a preconfigured period.

As another example, the fact that the initiation time point of the CAP is fixed may indicate that the transmission/reception structure of the communication device has one period. In this case, the fact that the initiation time point of the CAP is variable may indicate that, for the initiation time point of the CAP of the communication device, when the communication device is to transmit a signal via the unlicensed band, the transmission is possible at any time.

As another example, the fact that the initiation time point of the CAP is variable may indicate that the transmission/reception structure of the communication device does not have one period and may be determined when necessary.

Hereinafter, in the disclosure, a CAP or channel sensing is used interchangeably, but a CAP or channel sensing of a BS or a terminal may be the same.

Herein, a DL transmission burst may refer to a set of DL transmissions performed without a gap greater than 16 us between DL transmissions of a BS. When the gap between DL transmissions is greater than 16 μs, the DL transmissions may refer to separate DL transmission bursts. Similarly, a UL transmission burst may refer to a set of UL transmissions performed without a gap greater than 16 us between UL transmissions of a terminal. When the gap between UL transmissions is greater than 16 μs, the UL transmissions may refer to separate UL transmission bursts.

### <CAP for Semi-Static Channel Occupancy>

Hereinafter, description will be provided for a CAP when an initiation time point of a CAP of a communication device is fixed or semi-statically configured.

In a 5G system for performing communication in an unlicensed band, when it is possible to guarantee the absence of another system which shares and uses a channel in the unlicensed band for a long time by a regulation and a method at the same level as the regulation (by level of regulation), the following semi-static CAP or channel sensing may be performed.

A BS that is to use the semi-static CAP may provide, via higher layer signaling (e.g., SIB1 and/or RRC signaling), a terminal with configuration information indicating that a CAP scheme of the BS is the semi-static CAP and/or configuration information on the semi-static channel access, so as to enable the terminal to know that the CAP scheme of the BS is a semi-static channel access scheme. Here, an example of the configuration information on the semi-static channel access may be a period (Tₓ) in which the BS may start occupying a channel. For example, a value of the period may be 1 ms, 2 ms, 2.5 ms, 4 ms, 5 ms, or 10 ms. When using the semi-static CAP, the BS may initiate periodic channel occupancy every x·Tₓ starting from every Tₓ of two consecutive frames, i.e., a frame with an even-numbered index, and may occupy a channel during up to T_{y}=0.95Tₓ, where

$$x ∈ \{ 0 , 1 , … , \frac{20}{{T}_{x}} - 1 \} .$$

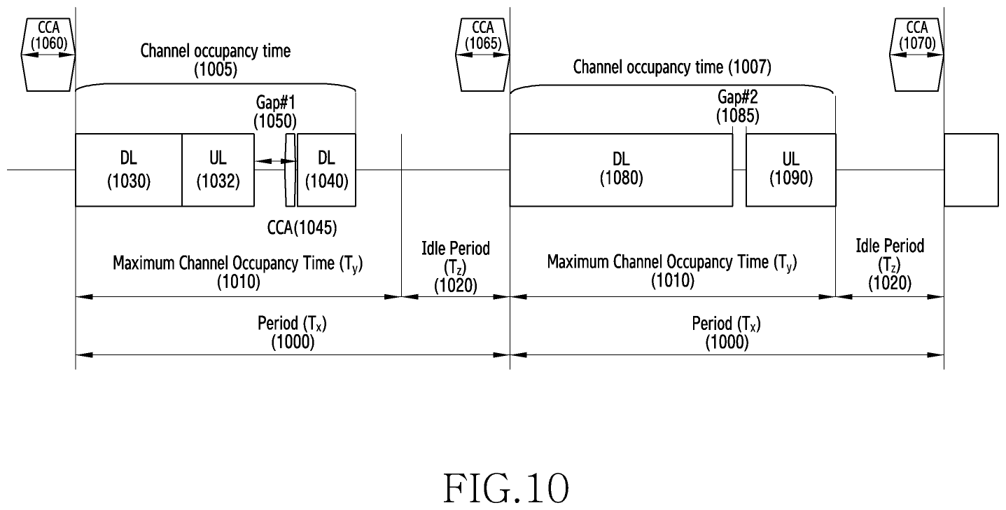

FIG. 10 illustrates a CAP for semi-static channel occupancy in a wireless communication system according to an embodiment.

Referring to FIG. 10, a periodic channel occupancy period (or semi-static periodic channel occupancy duration, Tₓ) 1000, channel occupancy times (COTs) 1005 and 1007, a maximum COT (T_{y}) 1010, an idle period (T_{z}) 1020, and channel assessment (clear channel assessment (CCA)) durations (or sensing slots, sensing durations, or sensing slot durations) 1060, 1065, and 1070 in a BS and a terminal which perform a semi-static CAP are illustrated.

The BS and terminal using the semi-static CAP may perform sensing for a channel in the channel assessment duration 1060 or 1065 which is immediately before using or occupying (e.g., DL transmission 1030 or DL transmission 1080) the channel in order to assess whether channel use (or channel occupancy) is possible. In this case, the sensing should be performed in at least one sensing slot duration, and an example of the sensing slot duration (Tₛₗ) is 9 μs.

An example of a sensing method may be comparing a magnitude or Intensity of a received power, which is detected or measured in a sensing slot duration, with a predefined, configured, or calculated threshold X_{Thresh}. For example, for the BS and terminal having performed sensing in the channel assessment duration 1060, when a result of the sensing is smaller than X_{Thresh}, the BS and the terminal may determine that the channel is idle or that using (or occupying) of the channel is possible, may occupy the channel, and may use the channel up to the maximum channel occupation time 1010. If a result of the sensing is equal to or greater than X_{Thresh}, the BS and the terminal may determine that the channel is busy or that using (or occupying) of the channel is not possible, and may not use the channel until the time 1080 at which initiation of subsequent channel occupancy is possible or the time 1065 at which channel sensing is performed in the subsequent channel assessment duration 1065.

When the BS performs the semi-static CAP and initiates channel occupancy, the BS and the terminal may perform communication as follows.
Immediately after the sensing slot duration is sensed to be idle, the BS should immediately perform DL transmission at a starting time point of a COT. If the sensing slot duration is sensed to be busy, the BS should not perform any transmission during the current COT.
When a gap 1050 between DL transmission 1040 which is to be performed by the BS within the channel occupation time 1005 and the previous DL transmission 1030 and UL transmission 1032 is greater than 16 μs, the BS may perform sensing for at least one sensing slot duration 1045, and may perform or may not be able to perform the DL transmission 1040 depending on a sensing result.
When the gap 1050 between the DL transmission 1040 which is to be performed by the BS within the channel occupation time 1005 and the previously performed UL transmission 1032 of the terminal is up to 16 μs (or equal to or smaller than 16 μs), the BS may perform the DL transmission 1040 without channel sensing (without the sensing slot duration 1045).
When the terminal performs UL transmission 1090 within the COT 1007 of the BS, if a gap 1085 between the UL transmission 1090 and the DL transmission 1080 is up to 16 μs (or equal to or smaller than 16 μs), the terminal may perform the UL transmission 1090 without channel sensing.
When the terminal performs UL transmission within the COT 1007 of the BS, if the gap 1085 between the UL transmission 1090 and the DL transmission 1080 is greater than 16 μs, the terminal may perform channel sensing in at least one sensing slot duration within a duration of 25 μs immediately before the UL transmission 1090, and may or may not perform the UL transmission 1090 depending on a sensing result.
The BS and the terminal should not perform any transmission in a set of consecutive symbols of at least T_{z}=max(0.05Tₓ, 100 μs) durations before starting of a subsequent COT.

### <CAP for Dynamic Channel Occupancy>

Hereinafter, description will be provided for a CAP when an initiation time point of a CAP of a communication device is variable or dynamic.

In a 5G system for performing communication in an unlicensed band, a BS may perform the following type of CAP or channel sensing when not using a semi-static CAP or when performing a dynamic CAP.

### First Type DL CAP

According to a first type DL CAP, the BS may, before DL transmission, perform sensing on a channel during a predetermined time or a time corresponding to the number of sensing slots corresponding to the predetermined time, and may perform the DL transmission when the channel is idle. The first type DL CAP will be described in more detail as follows.

In the first type DL CAP, parameters for the first type DL CAP may be determined according to a quality-of-service (QOS) class ID (QCI) or a 5G QOS ID (5QI) of a signal to be transmitted via a channel in an unlicensed band.

Table 18 below shows an example of a relationship between a channel access priority class and a QCI or 5QI. For example, QCIs 1, 2, and 4 may refer to QCI values for services, such as conversational voice, conversational video (live streaming), and non-conversational video (buffered streaming), respectively.

If a signal for a service which does not match the QCI or 5QI in Table 18 is to be transmitted in the unlicensed band, a transmission device may select a service and a QCI closest to the QCI or 5QI in Table 18 and select a channel access priority type therefor. In addition, if the signal to be transmitted via a channel in the unlicensed band has multiple different QCIs or 5QIs, a channel access priority class may be selected based on a QCI or 5QI having a lowest channel access priority class.

TABLE 18

| Channel | | | | | | |
|---|---|---|---|---|---|---|
| Access Priority | | | | | | Allowed |
| class (p) | QCI or 5QI | mₚ | CWₘᵢₙ | CW_{max, p} | T_{mcot, p} | CWₚ sizes |
| 1 | 1, 3, 5, 65, | 11 | 33 | 77 | 22 ms | {3, 7} |
| | 66, 69, 70, | | | | | |
| | 79, 80, 82, | | | | | |
| | 83, 84, 85 | | | | | |
| 2 | 2, 7, 71 | 11 | 77 | 115 | 22 ms | {7, 15} |
| 3 | 4, 6, 8, | 33 | 115 | 63 | 88 or | {15, 31, 63} |
| | 9, 72, 73, | | | | 10 ms | |
| | 74, 76 | | | | | |
| 4 | — | 77 | 115 | 11023 | 88 or | {15, 31, 63, |
| | | | | | 10 ms | 127, 255, |
| | | | | | | 511, 1023} |

If a channel access priority class value (p) is determined according to a QCI or a 5QI of the signal to be transmitted via the channel in the unlicensed band, a CAP may be performed using CAP parameters which correspond to the determined channel access priority class value. For example, as shown in Table 18, the CAP may be performed using mₚ which determines a length of a delay duration (deferring duration, T_{d}), a set (CWₚ) of contention window (CW) values or sizes, and minimum and maximum values (CW_{min,p}, CW_{max,p}) of a CW, which are CAP parameters corresponding to the channel access priority class value (p). In this case, after channel occupancy, a maximum available channel occupancy duration (T_{mcot,p}) may also be determined according to the channel access priority class value (p).

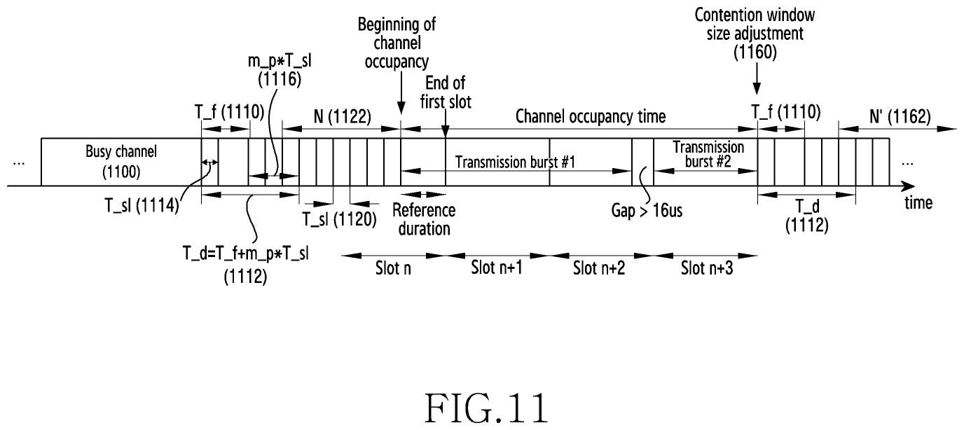

FIG. 11 illustrates a CAP for dynamic channel occupancy in a wireless communication system according to an embodiment. More specifically, FIG. 11 illustrates an example of the first type DL CAP of a BS.

Referring to FIG. 11, a BS that is to transmit a DL signal in an unlicensed band may perform a CAP within a delay time of at least T_{d} 1112. Here, the deferring duration T_{d} 1112 may sequentially include T_{f} 1110 and mₚ*Tₛₗ 1116. Here, T_{f} 1110 is 16 μs, and Tₛₗ 1114 and 1120 may refer to a length of a sensing slot. In this case, T_{f} 1110 includes one sensing slot 1114, and the sensing slot 1114 may be located at a starting time point of T_{f} 1110. When the BS performs the CAP with channel access priority class 3 (p=3) in Table 18, the deferring duration T_{d} 1112 required to perform the CAP may be determined as T_{f}+mₚ*Tₛₗ, where mₚ=3. When the first Tₛₗ 1114 of T_{f} 1110 is idle, the BS may not perform the CAP in the remaining time (T_{f}−Tₛₗ) after the first Tₛₗ 1114 of T_{f} 1110. In this case, even if the BS performs the CAP in the remaining time (T_{f}−Tₛₗ), a result of the CAP may not be used. In other words, the T_{f}−Tₛₗ time may refer to a time to delay the CAP regardless of the BS performing the CAP.

If it is determined that the unlicensed band is idle within T_{d} 1112, the BS may start channel occupancy after N sensing slots 1122. Here, N is an integer value randomly selected using 0 and a value (CWₚ) of a CW at or immediately before an initiation time point of the CAP. That is, N may be a value determined as N=rand(0, CWₚ). A detailed CW configuration method will be described again in the following. For example, for channel access priority class p=3 in Table 18, the minimum CW value and the maximum CW value are 15 and 63, respectively, and the allowed CW is {15, 31, 63}. Accordingly, the value of N may be randomly selected from one duration of 0 to 15, 0 to 31, or 0 to 63 depending on the CW value. The BS may perform sensing in every sensing slot, and when a strength of a received signal, which is measured in the sensing slot, is less than a threshold (X_{Thresh}), N may be updated to be N=N−1. If the strength of the received signal, which is measured in the sensing slot, is equal to or greater than the threshold (X_{Thresh}), the BS may perform channel sensing in the delay time (T_{d}) while maintaining, without subtracting, the value of N. If N=0 is determined, the BS may perform DL transmission. In this case, the BS may occupy and use the channel for a time of T_{mcot,p} according to Table 18 and the CAP class.

In an embodiment, CW size adjustment 1260 may be performed after a COT. After the CW size adjustment 1160, the deferring duration T_{d} 1112 required to perform the CAP may exist again. The time T_{f} 1110 may be included in the deferring duration T_{d} 1112. In addition, the CAP may be initiated after a duration of N′1162.

The first type of DL CAP may be divided into the following stages. The BS may sense that the channel is idle during the sensing slot duration of the delay time T_{d} 1112, and may perform DL transmission when a value of counter N is 0. In this case, counter N may be adjusted according to channel sensing performed in additional sensing slot duration(s) according to the following stages.

Stage 1: Configure N=Nᵢₙᵢₜ and move to stage 4. Here, Nᵢₙᵢₜ is a randomly selected number between 0 and CWₚ.

Stage 2: If N>0, the BS determines whether to decrement counter N. If it is determined to decrement the counter, configure N=N−1.

Stage 3: The BS senses the channel during an additional sensing slot duration. If it is determined that the channel is idle, move to stage 4. If the channel is not idle, move to stage 5.

Stage 4: If N=0, initiate DL transmission, and if not N=0, move to stage 2.

Stage 5: Sense the channel until a busy sensing slot is detected within the deferring duration T_{d}, or until all sensing slots within the deferring duration T_{d} are detected to be idle.

Stage 6: Move to stage 4 if all sensing slots within the deferring duration T_{d} are detected to be idle. Otherwise, move to stage 5.

A procedure of maintaining or adjusting a CW (CWₚ) value of the BS is as follows. In this case, a CW adjustment procedure may be applied when the BS performs DL transmission including at least a PDSCH corresponding to channel access priority class p, and may include the following stages.

Stage 1: Configure CWₚ=CW_{min,p} for all channel access priority classes p.

Stage 2:
If HARQ-ACK feedback is present (available) after last CWₚ update, move to stage 3.
In other cases, if DL transmission of the BS, which is performed after the first type CAP, does not include retransmission, or the DL transmission is performed within duration T_{w} immediately after a reference duration of a DL transmission burst transmitted first after the first type CAP after the last CWₚ update, move to stage 5.
In a case other than the above, move to stage 4.

Stage 3: HARQ-ACK feedback for a PDSCH transmitted in a reference duration of a most recent DL transmission burst, in which HARQ-ACK feedback for a PDSCH transmitted in a reference duration is present (available), may be used as follows.
If, among the HARQ-ACK feedback, at least one HARQ-ACK feedback among HARQ-ACK feedback for a PDSCH transmitted in units of transport blocks (TBs) is ACK, or among the HARQ-ACK feedback, at least 10% of HARQ-ACK feedback for a PDSCH transmitted in units of code block groups (CBGs) is ACK, move to stage 1.
Otherwise, move to stage 4.

Stage 4: For all channel access priority classes p, increase CWₚ to a next larger value compared to a current value among the allowed CWₚ values.
If currently CWₚ=CW_{max,p}, CWₚ allowed as the next larger value is CW_{max,p}.
If CWₚ=CW_{max,p} is continuously used K times to generate Nᵢₙᵢₜ, CWₚ may be initialized to CW_{min,p} for the channel access priority class p. In this case, K may be selected by the BS for each channel access priority class p from among {1, 2, . . . , 8}.

Stage 5: Maintain CWₚ for all channel access priority classes p, and move to stage 2.

In the above, duration T_{w} is max(T_{A}, T_{B}+1 ms). Here, T_{B} is an up/DL transmission burst duration from the start of the reference duration, and is a value in ms. In the 5G system for performing communication in an unlicensed band, when the absence of another system which shares and uses a channel in the unlicensed for a long time is guaranteed by a regulation and a method of the same level as that of the regulation, T_{A}=5 ms, and otherwise, T_{A}=10 ms.

A reference duration may refer to a duration occurring first in time among a duration from the start of channel occupancy including PDSCH transmission of the BS to the end of a first slot in the channel occupancy, in which at least one unicast PDSCH transmitted via all time-frequency resource areas allocated to a PDSCH is included, and a duration from the start of the channel occupancy to the end of a DL transmission burst, in which the at least one unicast PDSCH transmitted via all time-frequency resource areas allocated to the PDSCH is included. If the channel occupancy of the BS includes a unicast PDSCH, but does not include a unicast PDSCH transmitted via all time-frequency resource areas allocated to the PDSCH, a first DL transmission burst duration including the unicast PDSCH may be a reference duration. Here, the channel occupancy may refer to transmission performed by the BS after the CAP.

2A-th type DL CAP

According to a 2A-th type DL CAP, a BS may perform sensing on a channel at least in a duration of T_{short_dl}=25 μs immediately before DL transmission, and may perform DL transmission when the channel is idle. In this case, T_{short_dl} has a length of 25 μs, and T_{f}=16 μs and one sensing slot (Tₛₗ=9 μs) are sequentially configured. Here, T_{f} may include one sensing slot (Tₛₗ=9 μs), and a starting time of the sensing slot may be the same as a starting time of T_{f}. That is, T_{f} may start with the sensing slot (Tₛₗ). When the BS performs DL transmission that does not include a DL data channel transmitted to a specific terminal, the 2A-th type DL CAP may be performed.

2B-th type DL CAP

According to a 2B-th type DL CAP, a BS may perform sensing on a channel at least in a duration of T_{f}=16 μs immediately before DL transmission, and may perform DL transmission when the channel is idle. Here, T_{f} may include one sensing slot (Tₛₗ=9 μs), and the sensing slot may be located at last 9 μs. That is, T_{f} ends with a sensing slot (Tₛₗ). The 2B-th type DL CAP is applicable when a gap between the start of the DL transmission that is to be performed by the BS and the end of UL transmission of a terminal is 16 μs or is equal to or less than 16 μs.

2C-th type DL CAP

A 2C-th type DL CAP is applicable when a gap between the start of DL transmission by a BS and the end of UL transmission by a terminal is 16 μs or is equal to or less than 16 μs, and the BS may perform DL transmission without a separate procedure or channel sensing. In this case, a maximum duration of DL transmission performed after the 2C-th type DL CAP may be 584 μs.

Here, unlike the first DL CAP, for the 2A-th, 2B-th, and 2C-th type DL CAPs, a time point or a duration of channel sensing performed by the BS before DL transmission is deterministic. Based on such a characteristic, the DL CAPs may be further classified as follows.
Type 1: Type 1 is a type of performing DL transmission after performing a CAP during a variable time, and corresponds to the first type DL CAP.
Type 2: Type 2 is a type of performing DL transmission after performing a CAP during a fixed time, and corresponds to the 2A-th type and 2B-th type DL CAPs.
Type 3: Type 3 is a type of performing DL transmission without performing a CAP, and corresponds to the 2C-th type DL CAP.

### <Energy Detection Threshold Adjustment Procedure>

A BS performing a CAP or channel sensing may configure an energy detection threshold or sensing threshold X_{Thresh} as follows. In this case, X_{Thresh} needs to be configured to be a value equal to or smaller than a maximum energy detection threshold or X_{Thresh_max} indicating a sensing threshold, and X_{Thresh} is in dBm units.

In a 5G system for performing communication in an unlicensed band, when the absence of another system which shares and uses a channel in the unlicensed band for a long time is guaranteed by a regulation and a method of the same level as that of the regulation, X_{Thresh_max}=min{Tₘₐₓ+10 dB, Xᵣ}. Here, Xᵣ is a maximum energy detection threshold required by regional regulations, and is in dBm units. If the maximum energy detection threshold required by the regulation is not configured or defined, Xᵣ=Tₘₐₓ+10 dB.

For a case other than the above, i.e., in a 5G system for performing communication in an unlicensed band, when the absence of another system which shares and uses a channel in the unlicensed band for a long time cannot be guaranteed by a regulation and a method of the same level as that of the regulation, a maximum energy detection threshold may be determined as shown in Equation 1 below. However, Equation 1 is merely an example of a method for determining a maximum energy detection threshold, and the disclosed is not limited thereto.

$$〈 Equation 1 : ED threshold 〉$$

$${X}_{Thresh \_ max} = max \{ \begin{matrix}- 72 + 10 log 10 ( BW MHz / 20 MHz ) dBm , \\ min \{ \begin{matrix}{T}_{max} , \\ {T}_{max} - {T}_{A} + ( {P}_{H} + 10 log 10 ( BW MHz / 20 MHz ) - {P}_{TX}\end{matrix} \}\end{matrix} \}$$

In Equation 1, T_{A} is 10 dBm when transmission including a PDSCH is performed, and T_{A} is 5 dB when a discovery signal and a channel are transmitted. P_{H} is 23 dBm, and P_{TX} is a maximum output power of a BS and is in dBm units. The BS may calculate a threshold by using a maximum transmission power transmitted via one channel, regardless of whether DL transmission is performed via one channel or multiple channels. Here, Tₘₐₓ=10 log 10(3.16228*10⁻⁸ (mW/MHz)*BWMHz(MHz)), and BW is a bandwidth for one channel and is in MHz units.

In an embodiment, a method of determining an energy detection threshold X_{Thresh} for accessing a channel for UL transmission by a terminal is as follows.

A BS may configure a maximum energy detection threshold of a terminal via higher-layer signaling, for example, “maxEnergyDetectionThreshold”. The terminal which is provided or configured with “maxEnergyDetectionThreshold” from the BS may configure X_{Thresh_max} to be a value configured by the parameter. A terminal which is not provided or not configured with “maxEnergyDetectionThreshold” from the BS may configure X_{Thresh_max} as follows. If a terminal is not provided or configured with an energy detection threshold offset (e.g., energyDetectionThresholdOffset provided via higher-layer signaling) from the BS, the terminal may configure X_{Thresh_max} to be X′_{Thresh_max}. If the terminal is provided with or configured with the energy detection threshold offset from the BS, the terminal may configure X_{Thresh_max} to be a value obtained by adjusting X′_{Thresh_max} by the energy detection threshold offset. Here, X′_{Thresh_max} may be determined as follows.

In the 5G system for performing communication in an unlicensed band, when the absence of another system which shares and uses a channel in the unlicensed band for a long time is guaranteed by a regulation and a method of the same level as that of the regulation, the BS may provide the terminal with higher-layer signaling, for example, “absenceOfAnyOtherTechnology”. The terminal which is provided or configured with “absenceOfAnyOtherTechnology” via higher-layer signaling from the BS may configure X′_{Thresh_max}=min{Tₘₐₓ+10 dB, Xᵣ}. Here, Xᵣ is a maximum energy detection threshold required by regional regulations, and is in dBm units. If the maximum energy detection threshold required by the regulation is not configured or defined, Xᵣ=Tₘₐₓ+10 dB A terminal which is not provided or configured with “absenceOfAnyOtherTechnology” via higher-layer signaling from the BS may determine X′_{Thresh_max} via Equation 1. In this case, T_{A}=10 dBm, P_{H}=23 dBm, and P_{TX} is P_{CMAX_H,c}.

### <NCR>

Coverage is an important factor in a wireless communication system. Currently, 5G is commercialized, and millimeter wave is also included in commercialization, but due to limited coverage, there are not many actual uses. Accordingly, many operators are seeking economical methods while providing stable coverage at the same time. Although it is possible to expand coverage by installing multiple BSs, such implementation incurs significantly high costs.

A technology designed to find a more economical method, IAB, has been studied across 3GPP Rel-16 and Rel-17. IAB is a type of relay that does not require a backhaul network connected by wire, and serves to relay between a BS and a terminal. IAB is advantageous in view of having performance similar to that of the BS, but this makes it difficult to avoid an increase in installation and operation costs.

An RF repeater may also be considered. An RF repeater is a basic unit of repeater that amplifies and transmits an incoming signal. The RF repeater has an advantage of being inexpensive because the RF repeater simply amplifies and transmits a signal, but it is difficult to actively respond to various situations. For example, the RF repeater generally uses an omni-antenna without using a directional antenna, so that a beamforming gain cannot be obtained. In addition, the RF repeater may become a source of interference because the RF repeater amplifies and transmits noise even when there is no terminal connected to the RF repeater.

Each of the IAB and RF repeater may be advantageous in terms of performance and cost, but also has relative disadvantages. In order to realistically increase coverage, not only performance but also cost should be considered, so that a need for a new terminal or amplifier is emerging.

In 3GPP Rel-18, research is in progress for an NCR that maintains simple amplification and transmission of an RF repeater and maximizes coverage increase by enabling a beamforming technology with an adaptive antenna. In order for an NCR to transmit a signal to the terminal by using an adaptive antenna within a cell, the NCR should be able to receive a control signal of the BS. Accordingly, the NCR should be able to detect and decode the control signal of the BS, and therefore the NCR may have a transmission/reception structure for a control signal in a similar manner to that of the terminal. The NCR may fundamentally amplify a signal transmitted from the BS to transmit the amplified signal to the terminal, and may amplify a signal transmitted from the terminal to transmit the amplified signal to the BS. That is, the NCR may simply amplify and transmit a signal or channel transmitted and received between the BS and the terminal, without detecting or decoding the signal. Therefore, from the perspective of the terminal, it is unknown whether the NCR is involved in communication between the BS and the terminal.

In other words, from the perspective of the terminal, the BS and the NCR cannot be distinguished, and the NCR may appear to be the BS. Since the terminal does not require any additional information or operation for the NCR at all, the NCR may support a terminal corresponding to any release.

In addition, from the perspective of the BS, the NCR may be understood as a normal terminal. When the NCR is installed for the first time, the NCR may perform initial access to the BS like a normal terminal, and after higher-layer connection (e.g., RRC connection) to the BS is made, the NCR may receive configurations that may be received generally by the terminal from the BS. After being connected to the BS, the NCR may amplify a signal from the BS and transmit the same.

From the perspective of the BS, it is necessary to know whether the terminal is directly connected to the BS or is connected via the NCR. When the terminal is within the coverage of the NCR, the terminal may communicate with the BS via the NCR, and the BS may recognize this via implementation.

The BS may have knowledge of which terminal performs communication via which NCR, but the NCR has no knowledge of the same. Accordingly, regardless of a terminal that is within coverage of the NCR itself, the NCR may amplify and transmit a signal to the terminal under the control of the BS. In order for the BS to control the NCR, a control signal, which functions similarly to DCI for transmission of control information for the terminal, may be required. This control signal may be referred to as side control information (SCI). The SCI refers to control information on a control channel that the BS transmits to the NCR for controlling of the NCR, is a signal that is unknown to the terminal, and may only be recognizable by the BS and the NCR. The SCI may be transmitted on a PDCCH similarly to DCI.

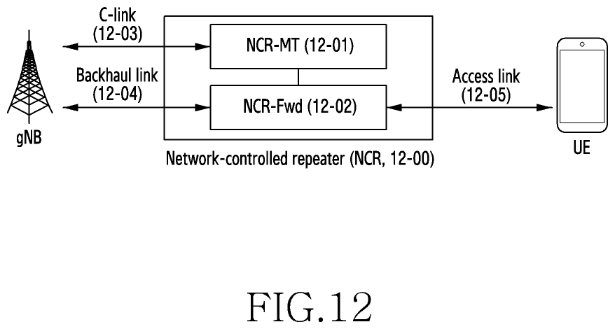

FIG. 12 illustrates transmission and reception related to an NCR when the NCR relays between a BS and a terminal according to an embodiment.

Referring to FIG. 12, an NCR 12-00 replays communication (e.g., DL and UL) between a BS and a terminal. The NCR 12-00 requires a structure and a function capable of transmitting and receiving control signaling of the BS, which may be performed by NCR-mobile termination (NCR-MT) 12-01 within the NCR. The NCR-MT 12-01 may receive control signaling from the BS via a control link (C-link) 12-03 and may transmit feedback to the BS. That is, from the perspective of the BS, the NCR-MT 12-01 appears to be a normal terminal, and therefore, communication may be performed with the NCR-MT 12-01. The BS may transmit control signaling to the NCR-MT 12-01 to control NCR-forwarding (NCR-Fwd) 12-02. The NCR-Fwd 12-02 may include only a basic RF or a physical layer, and may amplify a signal to transfer the same to the terminal. The NCR-Fwd 12-02 may receive a signal transmitted from the BS via a backhaul link 12-04 in a DL, and may transfer the signal to the terminal via an access link 12-05. In this case, since the backhaul link and the C-link are not necessarily physically separate links, the NCR 12-00 may amplify and transfer a signal via the backhaul link, and may concurrently detect, on the C-link, SCI configured by the BS to indicate an operation of the NCR 12-00. For a uplink, the NCR 12-00 may receive a uplink signal transmitted by the terminal via the access link 12-05, and may amplify and transfer the UL signal to the BS via the backhaul link 12-04. In this case, the NCR may transmit, to the BS, a signal or UL feedback for the SCI or higher-layer control.

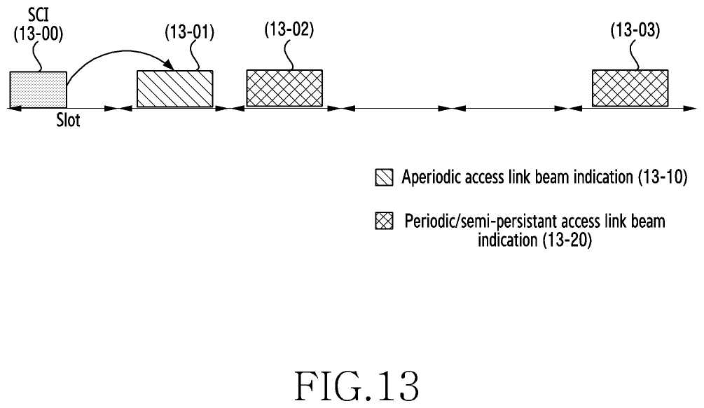

FIG. 13 illustrates an access link beam indication by an NCR under control of a BS according to an embodiment.

Referring to FIG. 13, an NCR may receive an access link beam indication periodically/semi-statically/aperiodically by control signaling of a BS. Reference numeral 13-01 of FIG. 13 illustrates a case in which the NCR aperiodically receives an indication 13-10 for an access link beam. The NCR may detect and decode SCI 13-00 to have knowledge of a beam index of the access link beam and a time resource corresponding to the beam. The NCR may amplify and transfer a signal on an access link via the indicated time resource and beam index.

Reference numerals 13-02 and 13-03 of FIG. 13 illustrate a case in which the NCR receives an indication 13-20 for an access link beam periodically or semi-statically with a period of 2 slots. The NCR may receive higher-layer signaling (RRC or MAC-CE), and may have knowledge of at least one of a period, a time resource, or a beam index of the access link beam from the received configuration information. When the NCR receives the configuration information or the indication for the access link beam, the NCR performs signal amplification and transferring on the indicated access link beam and the time resource. The NCR does not perform amplification and transmission in other durations. That is, the NCR-Fwd performs signal amplification and transferring only on time resources (e.g., one or more symbols) of reference numerals 13-01, 13-02, and 13-03, and does not operate on other time resources.

As described above, a time resource on which the NCR receives an access link beam indication from the BS may be referred to as forwarding window. In addition, an access link beam index and a time resource received by the NCR from the BS may be referred to as forwarding resource.

The SCI 13-00 detected by the NCR does not explicitly transfer whether an access link beam is applied to a UL or a DL. The NCR may determine a direction of the access link beam according to a UL or DL indicated by higher-layer signaling of tdd-UL-DL-ConfigurationCommon or tdd-UL-DL-ConfigurationDedicated received from the BS.

### <Access-Link Channel Access Method>

An NCR can operate in band FR1 or FR2. In band FR1 or FR2, there is an unlicensed band as well as a licensed band. A conventional NCR is defined under an assumption of a licensed band, and an operation in an unlicensed band is not considered. When an NCR operates in an unlicensed band without an agreed operation, there is a possibility of causing various problems, such as performance degradation or interference.

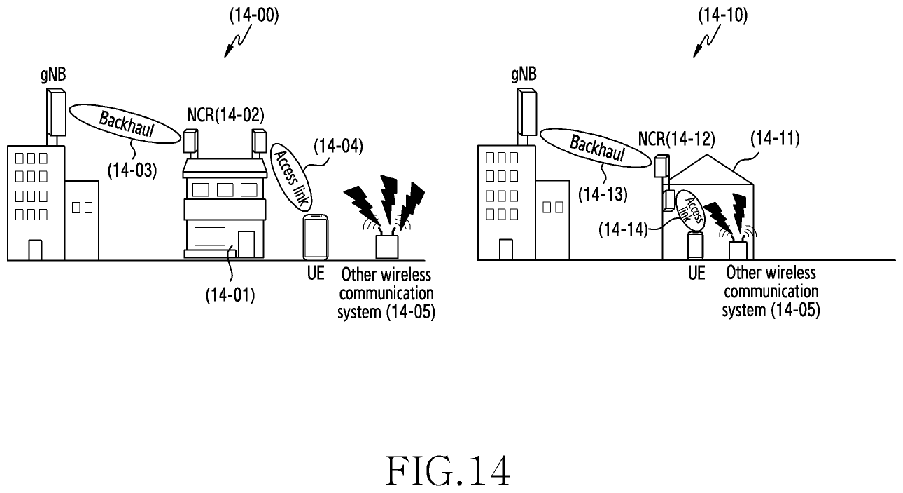

FIG. 14 illustrates an NCR operating in an unlicensed band according to an embodiment.

Referring to FIG. 14, reference numeral 14-00 is an unlicensed band, and a situation, in which an NCR 14-02 relays outdoors between a BS and a terminal with a building 14-01 in between, is illustrated. In general, the BS may perform channel access before transmitting a signal to and receiving a signal from the NCR. The BS may identify a channel idle state of a backhaul link 14-03, but there is a possibility that the BS may not be able to identify an idle state of an access link 14-04 due to the presence of the physically blocking building 14-01. Therefore, there may occur a hidden node problem that the BS is unable to identify a state of a channel even if another wireless communication system 14-05 occupies the channel.

Reference numeral 14-10 is an unlicensed band, and a situation, in which an NCR 14-12 relays between a BS outside a building 14-11 and a terminal inside the building 14-11, is illustrated. As in the case of reference numeral 14-00, the BS may detect a channel state of a backhaul link 14-13, but there is a possibility that the BS may not be able to detect a state of an access link 14-14 inside the building.

In order to address the above-described problem, the NCR should to perform channel access on the access link to detect a channel idle state of the access link. In order for the BS to perform transmission to and reception from the terminal by relaying the NCR, the BS and the NCR should perform channel access separately.

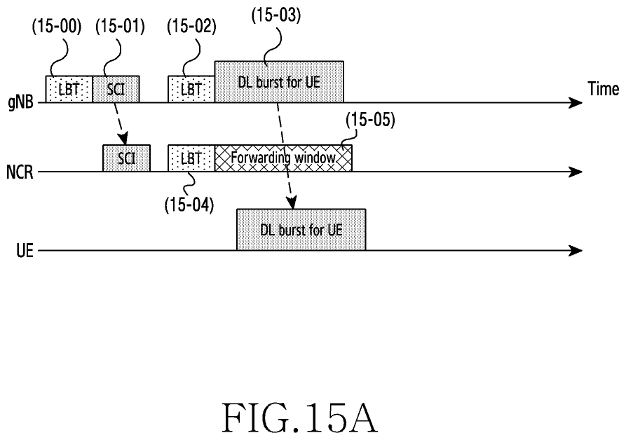

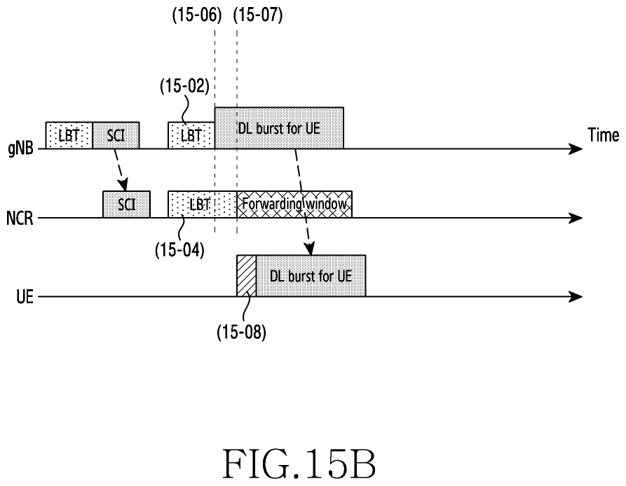

Hereinafter, FIG. 15A and FIG. 15B illustrate examples in which both a BS and an NCR perform channel access.

FIG. 15A illustrates a BS transmitting a signal to a terminal by relaying an NCR in a DL of an unlicensed band according to an embodiment.

Referring to FIG. 15A, a BS transmits control information for indicating a forwarding window 15-05 via SCI 15-01 to an NCR, and the BS may transmit DL burst data 15-03 to a terminal within the forwarding window 15-05. The BS preemptively performs LBT 15-00 on a C-link before transmitting the SCI 15-01, and if a C-link channel is idle, the BS transmits the SCI to the NCR. If the C-link of the NCR operates in a licensed band, the LBT 15-00 may not be required. The NCR performs LBT 15-04 on an access link before performing amplification and transferring in the forwarding window indicated in the SCI. In parallel, the BS also performs LBT 15-02 on a backhaul link to transmit the DL burst data 15-03. When both the LBT 15-02 of the BS on the backhaul link and the LBT 15-04 of the NCR on the access link are successful, the BS may be able to successfully transmit data to the terminal. In FIG. 15A, end points of the LBTs 15-02 and 15-04 of both links are illustrated to be similar.

FIG. 15B illustrates a BS performing transmission to a terminal by relaying an NCR in a DL of an unlicensed band according to an embodiment.

Referring to FIG. 15B, a BS transmits control information for indicating a forwarding window via SCI to an NCR, and the BS transmits DL burst data to a terminal within the forwarding window.

A difference between FIG. 15A and FIG. 15B is that, for FIG. 15B, a point 15-06 at which the backhaul link LBT 15-02 of the BS succeeds and a point 15-07 at which the access link LBT 15-04 of the NCR succeeds are different. In general, an LBT uses a random backoff scheme of selecting a random number and causing a delay for as many sensing slots as the random number. In FIG. 15B, because the BS and the NCR have independently selected random numbers, the point 15-06 at which the LBT of the BS succeeds and the point 15-07 at which the LBT of the NCR succeeds may be different. If the point 15-07 is greater than the point 15-06, only a part of the DL burst data transmitted by the BS may be transferred to the terminal. The terminal may not able to recognize results of the LBT 15-02 for the backhaul link and the LBT 15-04 for the access link, and may receive corrupted data 15-08 so as to fail in decoding. Accordingly, for successful transmission, the BS needs to transmit data to be transferred to the terminal at least after the NCR succeeds in LBT. In order to increase transmission reliability, the BS should identify information on a result of the access link LBT performed by the NCR.

As a solution for this, a BS and an NCR may share information on an access link LBT.

More specifically, a method is provided for a BS to indicate information on LBT to an NCR (method 1), or a method is provided in which the NCR transmits information on LBT to the BS (method 2). Hereinafter, access method 1 and access method 2 will be described in more detail.

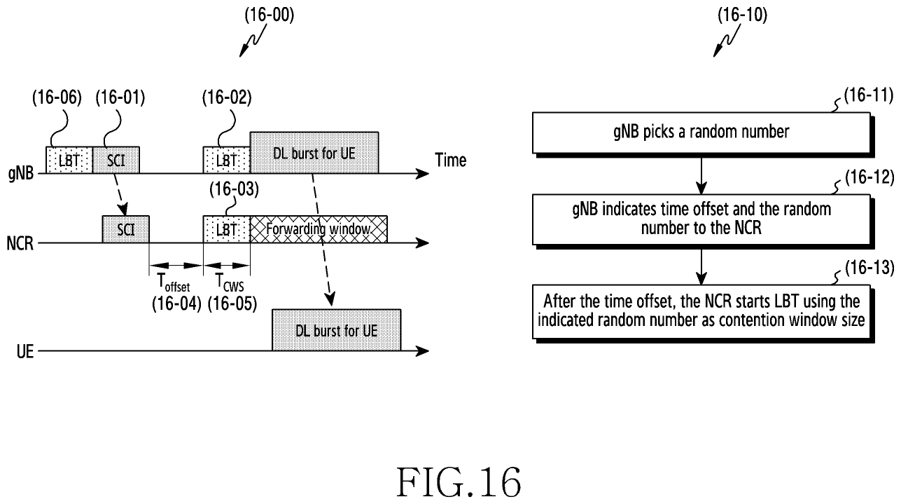

FIG. 16 illustrates method 1 in a DL of an unlicensed band according to an embodiment.

Referring to FIG. 16, reference numeral 16-00 illustrates an operation in which, after succeeding in LBT 16-06 for a C-link, a BS indicates a forwarding window to an NCR via SCI 16-01, and transmits DL burst data to a terminal within the forwarding window. In this case, if the C-link of the NCR operates in a licensed band, the LBT 16-06 may not be required. The BS may perform LBT 16-02 on a backhaul link before transmitting DL burst data. The NCR may also perform LBT 16-03 on an access link before the forwarding window. The NCR may receive configuration information or control information on the LBT 16-03 for the access link from the BS. The NCR may at least acquire information on time offset T_offset 16-04 and CW size T_CWS 16-05 via the SCI 16-01 received from the BS. Toffset includes time domain information on a time point at which the NCR is to start the access link LBT 16-03. If there is no additional configuration, a reference time of Toffset may be regarded as a last symbol of a PDCCH via which the SCI 16-01 is received. TCWS may include information on a CW size of the LBT 16-03.

Reference numeral 16-10 of FIG. 16 is a flowchart illustrating method 1 in time series.

Referring to the flowchart 16-10, the BS first selects 16-11 a random number before indicating a forwarding window of an NCR. If required to be applied, the random number may be determined randomly in consideration of a channel access priority class and CW size adjustment. In addition, the BS indicates 16-12 an appropriate time offset and the selected random number to the NCR. The NCR applies the random number as a CW size, and starts 16-13 performing an LBT operation after the time offset. The NCR performs the LBT 16-03 based on Toffset and TCWS indicated by the BS, and when a channel idle state is determined, signal amplification and power operation may be started immediately within the forwarding window. The BS may be able to transmit DL burst data in accordance with an expected success time point of the LBT 16-03 of the NCR.

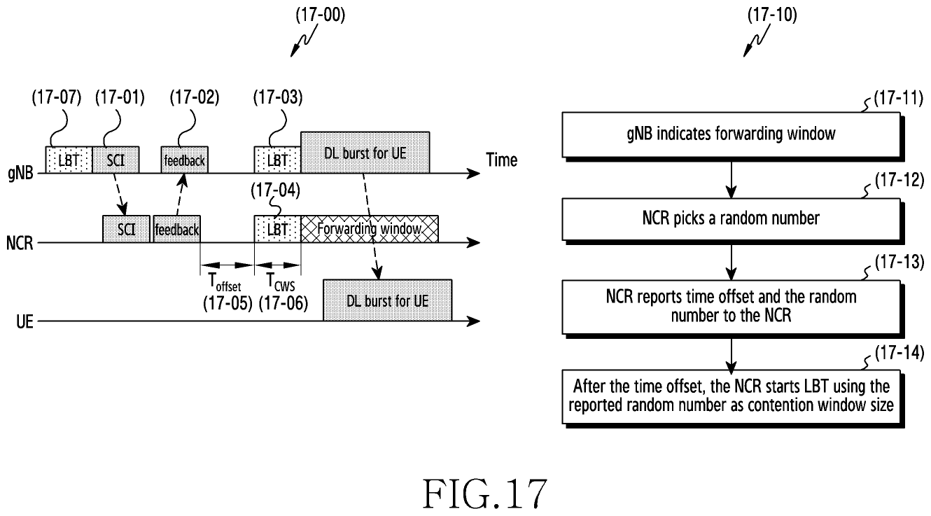

FIG. 17 illustrates method 2 in a DL of an unlicensed band according to an embodiment.

Referring to FIG. 17, reference numeral 17-00 illustrates an operation in which, after succeeding in LBT 17-07 for a C-link, a BS indicates a forwarding window to an NCR via SCI 17-01, and after the NCR transmits feedback 17-02 for the SCI 17-01 to the BS, the BS transmits DL burst data to a terminal within the forwarding window. In this case, if the C-link of the NCR operates in a licensed band, the LBT 17-07 may not be required. If a time interval between the SCI 17-01 received by the NCR and transmission of the feedback 17-02 corresponding to the SCI 17-01 exceeds a certain time, additional LBT for the C-link may be required. The feedback 17-02 transmitted by the NCR to the BS may include at least information on time offset Toffset 17-05 and CW size TCWS 17-06. Toffset includes time domain information on a time point at which the NCR is to start the access link LBT 17-04. If there is no additional configuration, a reference time of Toffset may be regarded as a last symbol of a channel or a signal via which the feedback 17-02 is transmitted. TCWS may include information on a CW size of the LBT 17-04.

Reference numeral 17-10 of FIG. 17 is a flowchart illustrating method 2 in time series.

Referring to flowchart 17-10, the BS first indicates 17-11 a forwarding window of the NCR. In this case, if required to be applied, indicated information may include information on a channel access priority class and CW size adjustment. The NCR selects 17-12 a random number after receiving the indication of the forwarding window from the BS. If required to be applied, the random number may be determined randomly in consideration of the channel access priority class and CW size adjustment. In addition, the NCR reports 17-13 an appropriate time offset and the selected random number to the

BS in consideration of the forwarding window. The NCR applies the random number as a CW size, and starts 17-14 performing an LBT operation after the time offset. The NCR performs the LBT 17-04 based on fed-back Toffset and TCWS, and when a channel idle state is determined, amplification and transferring may be started immediately within the forwarding window. The BS may be able to transmit DL burst data in accordance with an expected success time point of the LBT 17-04, based on the report of the NCR.

When the NCR performs access link LBT in method 1 and method 2 described above, and when a directional LBT is applicable, the BS may indicate an access link beam index to be used when the NCR performs the LBT. If there is no access link beam index indication for the LBT, the NCR may determine a beam according to a configured default beam or a predetermined criterion of the NCR itself.

When the NCR performs access link LBT in method 1 and method 2 described above, the BS may indicate a CAP type to be used when the NCR performs the LBT. If there is no relevant indication, the NCR may perform a first type CAP, or select another type of CAP.

### <Access-Link Channel Access Failure Feedback>

If an NCR fails an access-link CAP, the NCR may not be able to perform signal amplification and transferring within a forwarding window. In this case, when the BS transmits DL burst data to the terminal, because the NCR is unable to relay a signal, the BS either fails to receive HARQ-ACK from the terminal or receives a NACK. Since the BS has no knowledge of whether the access-link CAP of the NCR is successful, whether a reason for the transmission failure of DL data is a channel access failure or is link quality deterioration may not be determined. Therefore, if the BS has knowledge of whether the access-link CAP of the NCR is successful, an unnecessary radio link failure recovery procedure or beam failure recovery procedure may not be performed. Therefore, when the BS recognizes whether the access-link CAP of the NCR is successful, reliability may be improved and delays may be reduced, by relaying the NCR, during transmission and reception.

A methods for a BS to recognize the access-link CAP of the NCR includes the NCR reporting information on a CAP failure to the BS. If the CAP for the access link of the NCR fails before signal amplification and transferring in the forwarding window according to the indication of the BS, the NCR may report information on the result to the BS. On the other hand, if the CAP for the access link is successful, the NCR may not report the result to the BS. A resource for reporting the CAP may be configured in advance for the NCR by the BS. The BS having received the report of the NCR may be able to identify whether the access-link CAP has been successful.

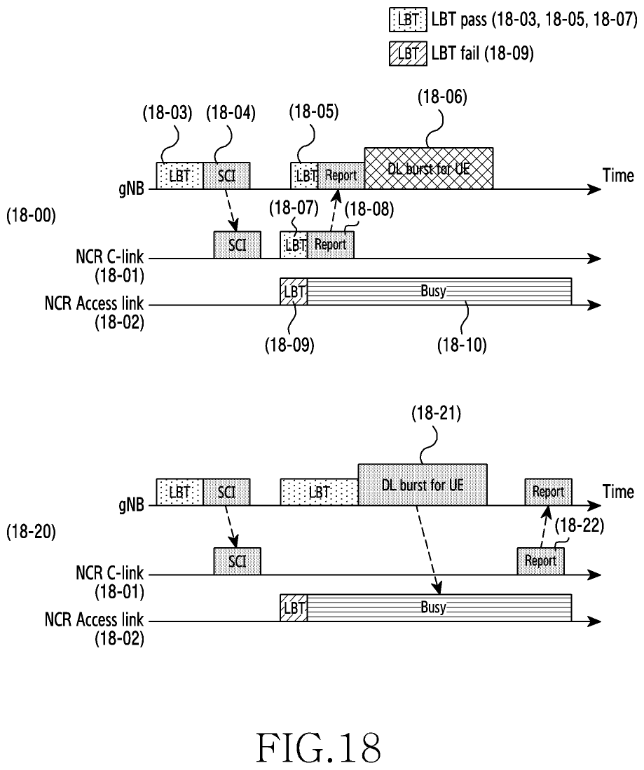

FIG. 18 illustrates an NCR access-link channel access failure report procedure in a DL of an unlicensed band according to an embodiment.

Referring to FIG. 18, reference numeral 18-00 illustrates a method in which LBT 18-09 for an access link of an NCR fails, and the NCR reports 18-08 information on the LBT 18-09 failure to a BS. In reference numeral 18-00, the BS performs LBT 18-03 for a C-link and transmits SCI 18-04 to the NCR. If the C-link operates in a licensed band, the LBT 18-03 may not be required. The NCR having detected the SCI identifies that a channel is occupied 18-10, while performing channel sensing 18-09 on an access link 18-02 (i.e., an LBT failure 18-09 for the access link 18-02).

After LBT 18-07 for the C-link 18-01 is successful in a configured slot or symbol, the NCR may transmit information for reporting a failure of the LBT 18-09 for the access link 18-02 to the BS by using a PUCCH or PUSCH resource. If the C-link 18-01 operates in a licensed band, the LBT 18-07 may not be required.

The BS may detect and receive the report 18-08 of the NCR while performing the LBT 18-05 before transmitting DL data burst 18-06. The BS may receive the report of the NCR, and may cancel the DL burst data 18-06 scheduled to be transmitted to a terminal, or perform the following procedure. For reference numeral 18-00, reporting may be possible when, after the LBT failure 18-09, the NCR has a resource to report the result to the BS. If, after the LBT failure, the NCR has no resource to report the result to the BS, a method of reference numeral 18-20 may be applied.

For reference numeral 18-00, the NCR may report the result for the LBT failure in a resource determined according to a predetermined rule. More specifically, the NCR may be able to report 18-22 the result of the LBT failure to the BS in a nearest UL slot after DL burst data 18-21 of the BS. If another channel or signal to be transmitted by the NCR is scheduled in the corresponding slot or symbol, whether to perform reporting may be determined according to a configuration. The NCR may be able to determine a UL or a DL via the BS's higher-layer signaling (e.g., tdd-UL-DL-ConfigurationCommon or tdd-UL-DL-ConfigurationDedicated), dynamic signaling (e.g., DCI format 2_0), or signaling for a forwarding window which will be described below. Since the LBT failure report 18-22 is transmitted, to the BS, as a response after transmission of the DL burst data by the BS, if a time interval between the DL burst data 18-21 and the LBT failure report 18-22 is sufficiently small, an LBT operation for the LBT failure report 18-22 may not be expected.

### <Access Link Beam Indication TDD Direction>

Forwarding window signaling indicated (e.g., via SCI, RRC, or MAC-CE) to the NCR by the BS in a licensed band does not explicitly transfer whether an access link beam is applied to a UL or a DL. The NCR may determine a direction of the access link beam according to UL or DL information directly or indirectly indicated by higher-layer signaling (e.g., tdd-UL-DL-ConfigurationCommon or tdd-UL-DL-ConfigurationDedicated) or dynamic signaling (e.g., DCI format 2_0).

Since a CAP is an essential element in an unlicensed band, there may be no UL or DL information indicated by higher-layer signaling, or both UL and DL information may be indicated as flexible symbols. Basically, the NCR does not perform signal amplification and transferring in flexible symbols, so that, if all slots are designated as flexible symbols, the NCR may not be able to perform signal amplification and transferring. In addition, the NCR and the terminal may not be able to receive dynamic signaling for indicating a slot format or a symbol type according to terminal capability. Consequently, there may occur a case in which, in an unlicensed band, the NCR may not be able to determine a UL or DL type of a specific symbol by using any signaling.

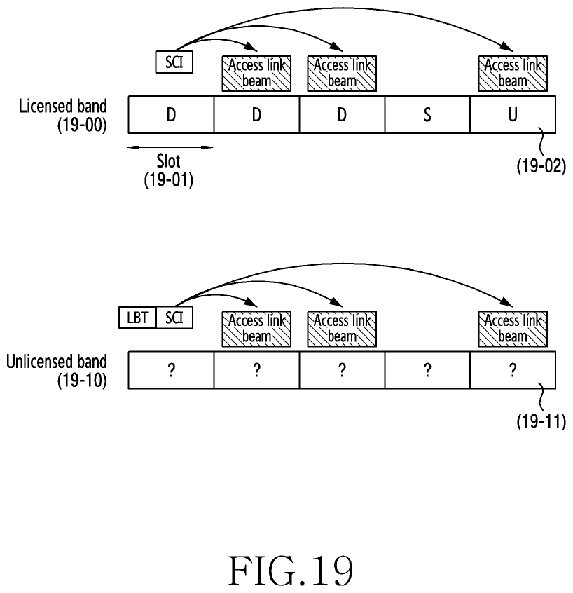

FIG. 19 illustrates a UL and a DL in an unlicensed band according to an embodiment.

Referring to FIG. 19, in a licensed band 19-00, an NCR may determine a direction of an access link beam in a forwarding window according to higher-layer signaling 19-02. In an unlicensed band, if higher-layer signaling or dynamic signaling is not provided, the NCR cannot determine 19-11 the direction of the access link beam.

To address the above-described problem, a method is provided for explicitly indicating UL or DL in signaling (e.g., SCI, RRC, or MAC-CE) for the forwarding window, which is transmitted by the BS to the NCR. If higher-layer signaling (e.g., tdd-UL-DL-ConfigurationCommon or tdd-UL-DL-ConfigurationDedicated) or dynamic signaling (e.g., DCI format 2_0) does not exist, or even if a symbol type is indicated via higher-layer signaling or dynamic signaling, in a case of a flexible symbol, the proposed method may be applicable. According to the method, the NCR may be able to acquire UL or DL information of a forwarding window from periodic/semi-static/dynamic signaling which is transmitted by the BS and indicates the forwarding window.

When the NCR is indicated with the forwarding window via periodic/semi-static signaling, the NCR receives a list including forwarding resources including {Access link beam index, time resource} via higher-layer signaling (e.g., RRC or MAC-CE).

When the NCR is indicated with the forwarding window via periodic/semi-static signaling, information for indicating a direction of the access link may be included in each list indicating forwarding resources. For example, when the NCR is indicated with {DL, forwarding resource #0, forwarding resource #1, forwarding resource #2} via higher-layer signaling, the NCR may be able to identify that forwarding resources (forwarding resources #0, 1, and 2) included in the list are DL resources. In other words, for the forwarding resources included in the list, access links may all be directed in the same direction. Accordingly, the NCR may determine the direction of the access link beam according to the directions indicated for the forwarding resources included in the forwarding resource list.

Alternatively, when the NCR is indicated with the forwarding window via periodic/semi-static signaling, a link direction indication may be included in each forwarding resource. For example, when the NCR is indicated with [{forwarding resource #0, DL}, {forwarding resource #1, DL}, {forwarding resource #2, UL} ] via higher-layer signaling, the NCR may be able to identify that forwarding resources #0 and 1 are DL resources and forwarding resource #2 is a UL resource. In other words, the forwarding resources included in the list may be indicated with different directions. Accordingly, the NCR may determine the direction of the access link beam according to the direction indicated for each forwarding resource.

When the NCR is indicated with the forwarding window via dynamic signaling, SCI for indicating the forwarding window may include one or more access link beam index fields and one or more time resource fields. In the time resource field, each entry may correspond to a table entry configured by one or a plurality of {symbol/slot offset, length}.

When the NCR is indicated with the forwarding window via dynamic signaling, an access link beam direction may be indicated via a newly added field in the SCI. For example, value “0” of the new field may indicate DL, and value “1” of the new field may indicate uplink. In this case, if the new field includes one bit, all time resources may be expected to have the same direction. If the new field includes multiple bits, the number of bits may be equal to the number of time resources, and each bit may correspond to one time resource.

Alternatively, when the NCR is indicated with the forwarding window via dynamic signaling, a link direction indication may be included in the time resource. For example, {symbol/slot offset, length, direction} may be included in the time resource included in the table entry configured via higher-layer signaling. When the NCR is indicated with the table entry via the time resource field, an access link beam direction configured for the corresponding forwarding window may be identified by referring to the time resource.

In this case, the direction indicated via signaling (e.g., SCI, RRC, or MAC-CE) for the forwarding window may not include a flexible symbol and may include only UL or DL.

After the NCR is explicitly indicated with UL or DL as the access link beam direction via signaling (e.g., SCI, RRC, or MAC-CE) for the forwarding window, if a corresponding forwarding window resource type is indicated to be UL or DL via higher-layer signaling (e.g., tdd-UL-DL-ConfigurationCommon or tdd-UL-DL-ConfigurationDedicated) or dynamic signaling (e.g., DCI format 2_0), the NCR may prioritize the direction indicated via higher-layer signaling or dynamic signaling. However, when the NCR receives a separate configuration relating to priority, the NCR may prioritize UL or DL explicitly indicated via signaling for the forwarding window. For example, if the BS indicates the forwarding window resource type to the NCR via higher-layer signaling or SCI, the NCR may determine the access link beam direction by prioritizing UL or DL explicitly indicated via signaling for the forwarding window.

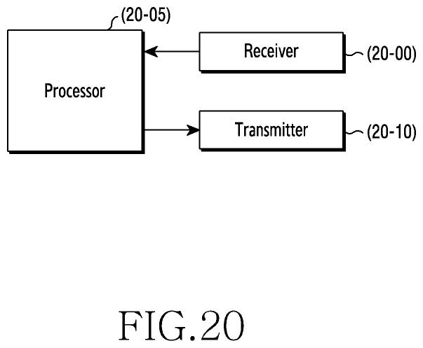

FIG. 20 illustrates a terminal in a wireless communication system according to an embodiment.

Referring to FIG. 20, a terminal includes a receiver 20-00, a transmitter 20-10, and a processor (or controller) 20-05.

For example, as described above, since an NCR which relays between a terminal and a BS appears to be the terminal from the perspective of the BS, the terminal of FIG. 20 in this case may be an NCR. For example, the NCR may include the receiver 20-00, the transmitter 20-10, and the processor (or controller) 20-05.

The receiver 18-00 and the transmitter 20-10 may be collectively referred to as a transceiver. The receiver 20-00, the transmitter 20-10, and the processor 20-05 of the terminal may operate according to the communication method of the terminal described above. However, the elements of the terminal are not limited to the aforementioned examples. For example, the terminal may include more elements (e.g., a memory, etc.) or fewer elements compared to the aforementioned elements. In addition, the receiver 20-00, the terminal 20-10, and the processor 20-05 may be implemented in the form of a single chip.

The receiver 20-00 and the transmitter 20-10 (or transceiver) may transmit a signal to and receive a signal from a BS. Here, the signal may include control information and data. To this end, the transceiver may include a radio frequency (RF) transmitter configured to perform amplification and up-conversion of a frequency of a transmitted signal, an RF receiver configured to perform low-noise amplification of a received signal and down-conversion of a frequency, etc. However, this is merely an embodiment of the transceiver, and the elements of the transceiver are not limited to the RF transmitter and the RF receiver.

In addition, the transceiver may receive a signal via a wireless channel and output the signal to the processor 20-05, and may transmit, via a wireless channel, the signal output from the processor 20-05.

The memory may store a program and data necessary for operations of the terminal. In addition, the memory may store control information or data included in a signal acquired by the terminal. The memory may include a storage medium or a combination of storage media, such as a read only memory (ROM), a random access memory (RAM), a hard disk, a compact disc (CD)-ROM, and a digital versatile disc (DVD).

The processor 20-05 may control a series of procedures so that the terminal is able to operate according to the aforementioned embodiments of the disclosure. The processor 20-05 may be implemented as a controller or one or more processors.

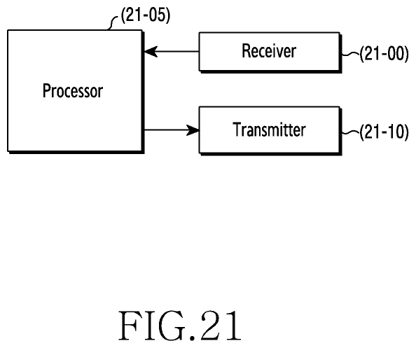

FIG. 21 illustrates a BS in a wireless communication system according to an embodiment.

Referring to FIG. 21, a BS includes a receiver 21-00, a transmitter 21-10, and a processor (controller) 21-05.

For example, as described above, since an NCR which relays between a terminal and a BS appears to be the BS from the perspective of the terminal, the BS of FIG. 21 in this case may be an NCR. For example, the NCR may include the receiver 21-00, the transmitter 21-10, and the processor (controller) 21-05.

The receiver 21-00 and the transmitter 21-10 may collectively be referred to as a transceiver. The receiver 21-00, the transmitter 21-10, and the processor 21-05 of the BS may operate according to the communication method of the BS described above. However, the elements of the BS are not limited to the above examples. For example, the BS may include more elements (e.g., a memory, etc.) or fewer elements compared to the aforementioned elements. In addition, the receiver 21-00, the transmitter 21-10, and the processor 21-05 may be implemented in the form of a single chip.

The receiver 21-00 and the transmitter 21-10 (or transceiver) may transmit a signal to and receive a signal from a terminal. Here, the signal may include control information and data. To this end, the transceiver may include an RF transmitter configured to perform amplification and up-conversion of a frequency of a transmitted signal, an RF receiver configured to perform low-noise amplification of a received signal and down-conversion of a frequency, etc. However, this is merely an embodiment of the transceiver, and the elements of the transceiver are not limited to the RF transmitter and the RF receiver.

In addition, the transceiver may receive a signal via a wireless channel and output the signal to the processor 21-05, and may transmit the signal output from the processor 21-05 via a wireless channel.

The memory may store program and data necessary for operations of the BS. In addition, the memory may store control information or data included in a signal acquired by the BS. The memory may include a storage medium or a combination of storage media, such as a ROM, a RAM, a hard disk, a CD-ROM, and a DVD.

The processor 21-05 may control a series of procedures so that the BS is able to operate according to the aforementioned embodiments of the disclosure. The processor 21-05 may be implemented as a controller or one or more processors.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essence of the disclosure. For example, it will be apparent that some or all of one or more embodiments may be combined with some or all of other one or more embodiments.

Moreover, although not set forth herein, methods that use separate tables or information including at least one element included in the tables proposed in the disclosure are also possible.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary.

While the disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method performed by a network-controlled repeater (NCR) in an unlicensed band in a wireless communication system, the method comprising:
receiving, from a base station (BS), control information indicating a forwarding window for transmitting data to a user equipment (UE);
performing a channel access procedure (CAP) for a channel between the NCR and the UE to identify whether the channel is idle; and
in case that the channel is idle,
receiving, from the BS, the data in the forwarding window; and
transmitting, to the UE, the data in the forwarding window.

2. The method of claim 1, further comprising receiving, from the BS, configuration information for the CAP;
wherein the configuration information includes time offset information indicating a starting time of the CAP and a contention window size, and
wherein the CAP is performed based on the configuration information.

3. The method of claim 1, further comprising transmitting, to the BS, feedback information for the CAP,
wherein the feedback information includes time offset information indicating a starting time of the CAP and information for a contention window size, and
wherein the CAP is performed based on the time offset information and the information for the contention window size.

4. The method of claim 1, wherein the control information includes information indicating downlink or uplink for time resources in the forwarding window.

5. The method of claim 1, wherein the CAP includes listen-before talk (LBT) or channel sensing.

6. A method performed by a base station (BS) in an unlicensed band in a wireless communication system, the method comprising:
performing a first channel access procedure (CAP) for a first channel between the BS and a network-controlled repeater (NCR) to identify whether the first channel is idle; and
in case that the first channel is idle,
transmitting, to the NCR, control information indicating a forwarding window for transmitting data to a user equipment (UE); and
transmitting, to the NCR, the data in the forwarding window.

7. The method of claim 6, further comprising transmitting, to the NCR, configuration information for a second CAP for a second channel between the NCR and the UE,
wherein the configuration information includes time offset information indicating a starting time of the second CAP and a contention window size, and
wherein transmitting, to the NCR, the data in the forwarding window is based on the configuration information.

8. The method of claim 6, further comprising receiving, from the NCR, feedback information for a second CAP for a second channel between the NCR and the UE,
wherein the feedback information includes time offset information indicating a starting time of the second CAP and information for a contention window size, and
wherein the transmitting, to the NCR, the data in the forwarding window is based on the feedback information.

9. The method of claim 6, wherein the control information includes information indicating downlink or uplink for time resources in the forwarding window.

10. The method of claim 6, wherein the first or second CAP includes listen-before talk (LBT) or channel sensing.

11. A network-controlled repeater (NCR) in an unlicensed band in a wireless communication system, the NCR comprising:
a transceiver; and
a processor coupled with the transceiver and configured to:
receive, from a base station (BS), control information indicating a forwarding window for transmitting data to a user equipment (UE),
perform a channel access procedure (CAP) for a channel between the NCR and the UE to identify whether the channel is idle, and
in case that the channel is idle,
receive, from the BS, the data in the forwarding window, and
transmit, to the UE, the data in the forwarding window.

12. The NCR of claim 11, wherein the processor further configured to receive, from the BS, configuration information for the CAP,
wherein the configuration information includes time offset information indicating a starting time of the CAP and a contention window size, and
wherein the CAP is performed based on the configuration information.

13. The NCR of claim 11, wherein the processor further configured to transmit, to the BS, feedback information for the CAP,
wherein the feedback information includes time offset information indicating a starting time of the CAP and information for a contention window size, and
wherein the CAP is performed based on the time offset information and the information for the contention window size.

14. The NCR of claim 11, wherein the control information includes information indicating downlink or uplink for time resources in the forwarding window.

15. The NCR of claim 11, wherein the CAP includes listen-before talk (LBT) or channel sensing.

16. A base station (BS) in unlicensed band in a wireless communication system, the BS comprising:
a transceiver; and
a processor coupled with the transceiver and configured to:
perform a first channel access procedure (CAP) for a first channel between the BS and a network-controlled repeater (NCR) to identify whether the first channel is idle, and
in case that the first link is idle,
transmit, to the NCR, control information indicating a forwarding window for transmitting data to a user equipment (UE), and
transmit, to the NCR, the data in the forwarding window.

17. The BS of claim 16, wherein the processor further configured to transmit, to the NCR, configuration information for a second CAP for a second channel between the NCR and the UE,
wherein the configuration information includes time offset information indicating a starting time of the second CAP and a contention window size, and
wherein the data is transmitted to the NCR in the forwarding window based on the configuration information.

18. The BS of claim 16, wherein the processor further configured to receive, from the NCR, feedback information for a second CAP for a second channel between the NCR and the UE,
wherein the feedback information includes time offset information indicating a starting time of the second CAP and information for a contention window size, and
wherein the data is transmitted to the NCR in the forwarding window based on the configuration information.

19. The BS of claim 16, wherein the control information includes information indicating downlink or uplink for time resources in the forwarding window.

20. The BS of claim 16, wherein the first or second CAP includes listen-before talk (LBT) or channel sensing.
